(19) United States
(12) Patent Application Publication
(10) Pub. No.: US 2025/0260734 A1
(43) Pub. Date: Aug. 14, 2025

(54) SERVICE OPERATIONS FOR APPLICATION PROGRAMMING INTERFACES (APIs)

(71) Applicant: Lenovo (Singapore) Pte. Limited, Singapore (SG)

(72) Inventor: Roozbeh Atarius, La Jolla, CA (US)

(73) Assignee: Lenovo (Singapore) Pte. Limited, Singapore (SG)

(21) Appl. No.: 19/048,388

(22) Filed: Feb. 7, 2025

Related U.S. Application Data
(60) Provisional application No. 63/553,621, filed on Feb. 14, 2024.

(51) Int. Cl. H04L 67/02; G06F 9/54

(52) U.S. Cl. CPC H04L 67/02; G06F 9/547

(57) ABSTRACT

Various aspects of the present disclosure relate to service operations for Application Programming Interfaces (APIs). A first network equipment (NE) transmits, to a second NE, a request message for a service operation, the request message including a resource Uniform Resource Identifier (URI) for a Hypertext Transfer Protocol (HTTP) POST method, and the service operation includes one or more of an initial Application Programming Interface (API) configuration, an API configuration update, or an API invocation associated with an API provider. The first NE receives, from the second NE, a response message including a result of the service operation.

### RELATED APPLICATION

This application claims priority to U.S. Provisional Application Ser. No. 63/553,621, filed 14 Feb. 2024 entitled “SERVICE OPERATIONS FOR APPLICATION PROGRAMMING INTERFACES (APIs),” the disclosure of which is incorporated by reference herein in its entirety.

### TECHNICAL FIELD

The present disclosure relates to wireless communications, and more specifically to utilizing Application Programming Interfaces (APIs) in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” cannot be construed as a reference to a closed set of conditions. For example, an example step that is described as “based on condition A” may be based on both a condition A and a condition B without departing from the scope of the present disclosure. In other words, as used herein, the phrase “based on” can be construed in the same manner as the phrase “based at least in part on”. Further, as used herein, including in the claims, a “set” may include one or more elements.

Some implementations of the method and apparatuses described herein may further include a NE for wireless communication to transmit, to a second NE, a request message for a service operation, the request message including a resource Uniform Resource Identifier (URI) for a Hypertext Transfer Protocol (HTTP) POST method, and the service operation including one of an initial Application Programming Interface (API) configuration or an API configuration update; and receive, from the second NE, a response message including a result of the service operation.

In some implementations of the method and apparatuses for a NE described herein, the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; the at least one processor is configured to cause the first NE to receive, from the second NE, a response including slice API information; the response includes {apiRoot}/nsce-sac/<apiVersion>/apiInfo}; the first NE includes a Vertical Application Layer (VAL) server; the second NE includes a Network Slice Capability Exposure (NSCE) Server; the service operation pertains to one or more network slice APIs.

Some implementations of the method and apparatuses described herein may further include a method performed by a NE, the method including transmitting, to a second NE, a request message for a service operation, the request message including a resource URI for a HTTP POST method, and the service operation including one of an initial API configuration or an API configuration update; and receiving, from the second NE, a response message including a result of the service operation.

In some implementations of the method and apparatuses for a NE described herein, the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; In some aspects, the techniques described herein relate to a method, further including receiving, from the second NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

Some implementations of the method and apparatuses described herein may further include a NE for wireless communication to receive, from a first NE, a request message for a service operation, the request message including a resource URI for a HTTP POST method, and the service operation including one of an initial API configuration or an API configuration update; perform the service operation; and transmit, to the first NE, a response message including a result of the service operation.

In some implementations of the method and apparatuses for a NE described herein, the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; the at least one processor is configured to cause the second NE to transmit, to the first NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

Some implementations of the method and apparatuses described herein may further include a method performed by a NE, the method including receiving, from a first NE, a request message for a service operation, the request message including a resource URI for a HTTP POST method, and the service operation including one of an initial API configuration or an API configuration update; performing the service operation; and transmitting, to the first NE, a response message including a result of the service operation.

In some implementations of the method and apparatuses for a NE described herein, the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; In some aspects, the techniques described herein relate to a method, further including transmitting, to the first NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

Some implementations of the method and apparatuses described herein may further include a NE for wireless communication to transmit, to a second NE, a request message for a service operation, the request message including a resource URI for a HTTP POST method, and the service operation including an API invocation associated with an API provider; and receive, from the second NE, a response message including a result of the service operation.

In some implementations of the method and apparatuses for a NE described herein, the request message further includes one or more data types for the request message; the one or more data types include information pertaining to one or more of an identifier for a network slice for which the API invocation is requested or authorization information for the API invocation; the operation URI includes {apiRoot}/nsce-sai/<apiVersion>/ApiInvoc; the first NE includes a VAL server; the second NE includes a NSCE Server; the service operation pertains to invocation of one or more network slice APIs; the response message includes one or more of a result of the API invocation or an indication of one or more configuration errors.

Some implementations of the method and apparatuses described herein may further include a method performed by a NE, the method including transmitting, to a second NE, a request message for a service operation, the request message including a resource URI for a HTTP POST method, and the service operation including an API invocation associated with an API provider; and receiving, from the second NE, a response message including a result of the service operation.

In some implementations of the method and apparatuses for a NE described herein, the request message further includes one or more data types for the request message; the one or more data types include information pertaining to one or more of an identifier for a network slice for which the API invocation is requested or authorization information for the API invocation; the operation URI includes {apiRoot}/nsce-sai/<apiVersion>/ApiInvoc; the first NE includes a VAL server; the second NE includes a NSCE Server; the service operation pertains to invocation of one or more network slice APIs; the response message includes one or more of a result of the API invocation or an indication of one or more configuration errors.

Some implementations of the method and apparatuses described herein may further include a NE for wireless communication to receive, from a first NE, a request message for a service operation, the request message including a resource URI for a HTTP POST method, and the service operation including an API invocation associated with an API provider; perform the service operation; and transmit, to the first NE, a response message including a result of the service operation.

In some implementations of the method and apparatuses for a NE described herein, the request message further includes one or more data types for the request message; the one or more data types include information pertaining to one or more of an identifier for a network slice for which the API invocation is requested or authorization information for the API invocation; the at least one processor is configured to cause the second NE to one or more of: verify, based at least in part on the information of the one or more data types, an identity of the first NE; or determine, based at least in part on the information of the one or more data types, whether the first NE is authorized to request the API invocation; the response includes {apiRoot}/nsce-sai/<apiVersion>/ApiInvoc; to perform the service operation, the at least one processor is configured to cause the second NE to translate the API invocation to a service API invocation; to translate the API invocation to the service API invocation, the at least one processor is configured to cause the second NE to map a network slice for the API invocation to the service API; the first NE includes a VAL server; the second NE includes a NSCE Server; the service operation pertains to invocation of one or more network slice APIs; the response message includes one or more of a result of the API invocation or an indication of one or more configuration errors.

Some implementations of the method and apparatuses described herein may further include a method performed by a NE, the method including transmitting, to a second NE, a request message for a service operation, the request message including a resource URI for a HTTP POST method, and the service operation including an API invocation associated with an API provider; and receiving, from the second NE, a response message including a result of the service operation.

In some implementations of the method and apparatuses for a NE described herein, the request message further includes one or more data types for the request message; the one or more data types include information pertaining to one or more of an identifier for a network slice for which the API invocation is requested or authorization information for the API invocation; the operation URI includes {apiRoot}/nsce-sai/<apiVersion>/ApiInvoc; the first NE includes a VAL server; the second NE includes a NSCE Server; the service operation pertains to invocation of one or more network slice APIs; the response message includes one or more of a result of the API invocation or an indication of one or more configuration errors.

Some implementations of the method and apparatuses described herein may further include a NE for wireless communication to transmit, to a second NE, a request message for a service operation, the request message including a resource URI for a HTTP POST method, and the service operation including one or more of an initial API configuration, an API configuration update, or an API invocation associated with an API provider; and receive, from the second NE, a response message including a result of the service operation.

In some implementations of the method and apparatuses for a NE described herein, the request message further includes one or more data types for the request message; the one or more data types include information pertaining to one or more of the initial API configuration, the API configuration update, or the API invocation; the operation URI includes one or more of {apiRoot}/nscc-sam/<apiVersion>/Reqt, {apiRoot}/nsce-sam/<apiVersion>/UpdReqt, or {apiRoot}/nsce-sam/<apiVersion>/ApiInvoc; the at least one processor is configured to cause the first NE to receive, from the second NE, a response including slice API information; the response comprises {apiRoot}/nsce-sam/<apiVersion>/apiInfo}; the first NE includes a VAL server; the second NE includes a NSCE Server; the service operation pertains to one or more network slice APIs.

Some implementations of the method and apparatuses described herein may further include a method performed by a NE, the method including transmitting, to a second NE, a request message for a service operation, the request message including a resource URI for a HTTP POST method, and the service operation including one or more of an initial API configuration, an API configuration update, or an API invocation associated with an API provider; and receiving, from the second NE, a response message including a result of the service operation.

In some implementations of the method and apparatuses for a NE described herein, the request message further includes one or more data types for the request message; the one or more data types include information pertaining to one or more of the initial API configuration, the API configuration update, or the API invocation; the operation URI includes one or more of {apiRoot}/nsce-sam/<apiVersion>/Reqt, {apiRoot}/nsce-sam/<apiVersion>/UpdReqt, or {apiRoot}/nscc-sam/<apiVersion>/ApiInvoc; In some aspects, the techniques described herein relate to a method, further including receiving, from the second NE, a response including slice API information; the response includes {apiRoot}/nsce-sam/<apiVersion>/apiInfo}; the first NE includes a VAL server; the second NE includes a NSCE Server; the service operation pertains to one or more network slice APIs.

Some implementations of the method and apparatuses described herein may further include a NE for wireless communication to receive, from a first NE, a request message for a service operation, the request message including an operation URI for a HTTP POST method, and the service operation including one or more of an initial API configuration, an API configuration update, or an API invocation associated with an API provider; perform the service operation; and transmit, to the first NE, a response message including a result of the service operation.

In some implementations of the method and apparatuses for a NE described herein, the request message further includes one or more data types for the request message; the one or more data types include information pertaining to one or more of the initial API configuration of the API configuration update; the operation URI includes one or more of {{apiRoot}/nsce-sam/<apiVersion>/Reqt, {apiRoot}/nsce-sam/<apiVersion>/UpdReqt, or {apiRoot}/nsce-sam/<apiVersion>/ApiInvoc; the at least one processor is configured to cause the second NE to transmit, to the first NE, a response including slice API information; the response comprises {apiRoot}/nscc-sam/<apiVersion>/apiInfo}; the first NE includes a VAL server; the second NE includes a NSCE Server; the service operation pertains to one or more network slice APIs.

Some implementations of the method and apparatuses described herein may further include a method performed by a NE, the method including receiving, from a first NE, a request message for a service operation, the request message including an operation URI for a HTTP POST method, and the service operation including one or more of an initial API configuration, an API configuration update, or an API invocation associated with an API provider; performing the service operation; and transmitting, to the first NE, a response message including a result of the service operation.

In some implementations of the method and apparatuses for a NE described herein, the request message further includes one or more data types for the request message; the one or more data types include information pertaining to one or more of the initial API configuration of the API configuration update; the response message includes one or more of {{apiRoot}/nsce-sam/<apiVersion>/Reqt, {apiRoot}/nsce-sam/<apiVersion>/UpdReqt, or {apiRoot}/nsce-sam/<apiVersion>/ApiInvoc; In some aspects, the techniques described herein relate to a method, further including transmitting, to the first NE, a response including slice API information; the response includes {apiRoot}/nsce-sam/<apiVersion>/apiInfo}; the first NE includes a VAL server; the second NE includes a NSCE Server; the service operation pertains to one or more network slice APIs.

### BRIEF DESCRIPTION OF THE DRAWINGS

FIG. 1 illustrates an example of a wireless communications system in accordance with aspects of the present disclosure.

FIG. 2 illustrates an example signaling diagram for initial slice API configuration.

FIG. 3 illustrates an example signaling diagram for slice API configuration update based on a trigger event.

FIG. 4 illustrates an example signaling diagram for slice API translation based on an initial configuration.

FIG. 5 illustrates an example resource URI structure in accordance with aspects of the present disclosure.

FIG. 6 illustrates an example resource URI structure in accordance with aspects of the present disclosure.

FIG. 7 illustrates an example resource URI structure in accordance with aspects of the present disclosure.

FIG. 8 illustrates an example of a NE in accordance with aspects of the present disclosure.

FIG. 9 illustrates an example of a processor in accordance with aspects of the present disclosure.

FIG. 10 illustrates a flowchart of a method in accordance with aspects of the present disclosure.

FIG. 11 illustrates a flowchart of a method in accordance with aspects of the present disclosure.

FIG. 12 illustrates a flowchart of a method in accordance with aspects of the present disclosure.

FIG. 13 illustrates a flowchart of a method in accordance with aspects of the present disclosure.

FIG. 14 illustrates a flowchart of a method in accordance with aspects of the present disclosure.

FIG. 15 illustrates a flowchart of a method in accordance with aspects of the present disclosure.

### DETAILED DESCRIPTION

Wireless communications systems such as 5G networks can utilize network slicing to enable network operators to divide a single physical network into multiple distinct virtual connections, each tailored to specific types of traffic. Virtual slices can provide different types and amounts of resources that enable diverse functionality. To enable network slice configuration and expose functionality and services of network slices, APIs can be utilized. However, creating APIs and related resources (e.g., URIs) and data models for network slicing presents a number of challenges.

Accordingly, aspects of the disclosure are directed to a framework for defining API-related services including service operations for which methods and associated resources (e.g., URIs) and related data types can be defined. The described solutions can thus provide more efficient wireless network slicing and enable more robust exposure of wireless network slice-related services.

Aspects of the present disclosure are described in the context of a wireless communications system.

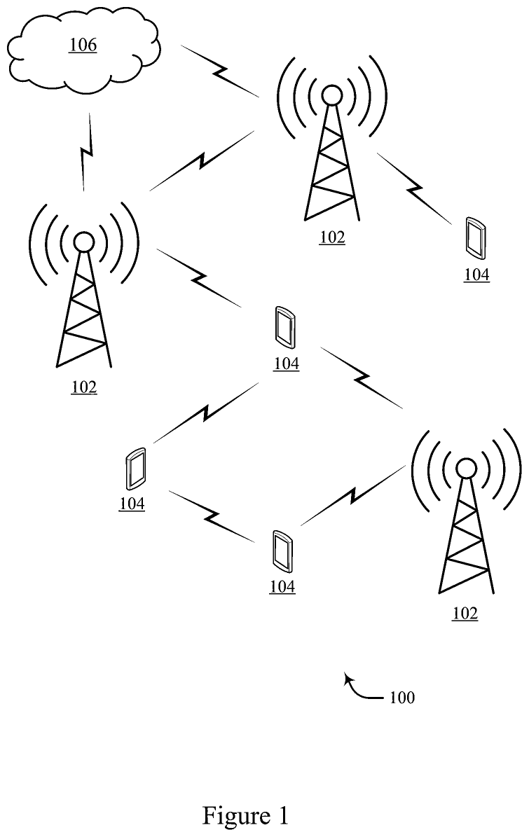

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 KHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, different NE 102 and the CN 106 can implement various entities such as VAL servers, NSCE servers, API providers, etc. For instance, VAL servers and NSCE servers can interact as part of network slicing in the context of the wireless communications system 100 to enable functionality such as slice API configuration, slice API configuration updating, slice API invocation, etc., to configure and expose functionality and services of network slice APIs.

With reference to utilization of APIs in network slices, clause 9.3 of 3GPP Technical Specification (TS) 23.435 specifies stage 2 of slice API configuration and translation functionality which is provided to the vertical application layer (VAL) and configures the exposure of APIs in a slice-tailored manner. (See 3GPP TS 23.435, Release 18, Version 18.1.0, Jan. 5, 2024, titled “Procedures for Network Slice Capability Exposure for Application Layer Enablement Service,” hereinafter referred to as “3GPP TS 23.435”, which is hereby incorporated by reference herein in its entirety) It can be assumed that the VAL server is not initially aware of the API exposure capabilities and information for the given slice based on the Service Level Agreement (SLA), and NSCE can assist in configuring and translating a slice API based on the per slice requirements to service APIs. Further, clause 9.3 of 3GPP TS 23.435 lists two procedures on slice API configuration and one procedure on slice API translation.

With reference to initial configuration procedures for slice API configuration, a VAL server can initially provide an application parameter to enabler server including the service Key Performance Indicators (KPIs) and the subscribed/preferred slices. The slice enabler can then configure the mapping of the VAL application to a slice API which can be a combination and/or bundling of northbound APIs, such as from both management and control plane. A slice API can include telco-provided and/or platform dependent service APIs (e.g., Network Exposure Function (NEF), Operations, Administration and Management/Maintenance (OAM), Service Enabler Architecture Layer for Verticals (SEAL), etc.), and can provide an abstraction and/or simplification of the service APIs.

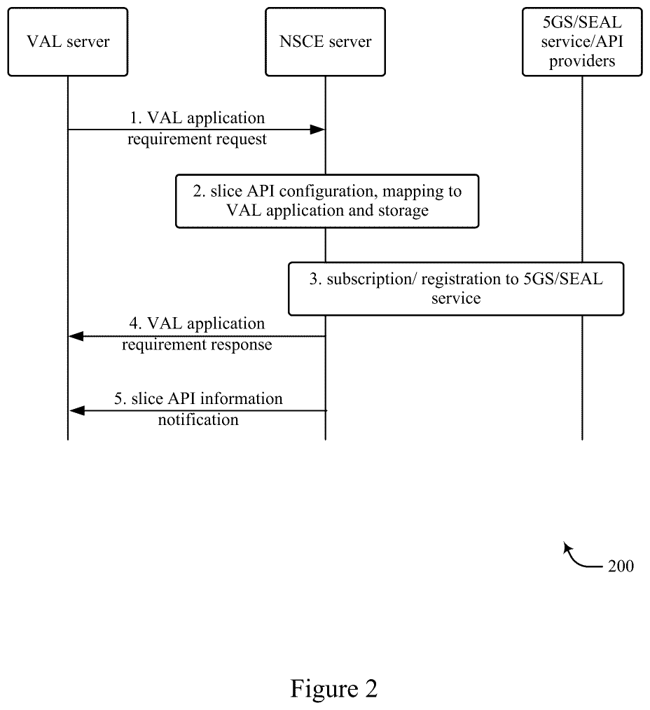

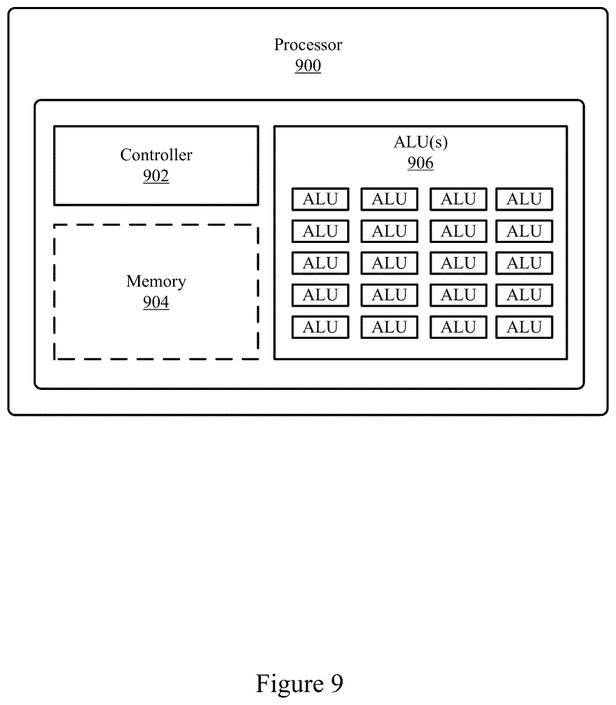

FIG. 2 illustrates an example signaling diagram 200 for initial slice API configuration. The signaling diagram 200, for instance, is based on FIG. 9.3.2.1.2-1 in 3GPP TS 23.435. In the signaling diagram 200: (1) The VAL server sends a VAL application requirement request to the NSCE server; (2) The NSCE server maps the VAL application requirement to a slice API which includes a list of APIs which is to be consumed as part of this service capability exposure. The NSCE server may also store the mapping of the slice API to the service API list and per service API information (e.g. data encoding, transport technology, API protocol and versions); (3) The NSCE server registers to consume the corresponding APIs from the 5GS (NEF and OAM) and SEAL service producers. The NSCE server registers to the following: to consume NEF monitoring events as specified in 3GPP TS 29.522 clause 5 e.g., network monitoring, slice status, analytics exposure, etc.; to consume Performance Monitoring (PM) services and KPI monitoring from OAM (see 3GPP TS 29.522, Release 18, Version 18.4.0, Dec. 18, 2023, titled “5G System; Network Exposure Function Northbound APIs; Stage 3,” hereinafter referred to as “3GPP TS 29.522”, which is hereby incorporated by reference herein in its entirety); to consume SEAL services based on 3GPP TS 23.434 (see 3GPP TS 23.434, Release 18, Version 18.7.0, Jan. 5, 2024, titled “Service Enabler Architecture Layer for Verticals (SEAL); Functional architecture and information flows,” hereinafter referred to as “3GPP TS 23.434”, which is hereby incorporated by reference herein in its entirety); (4) The NSCE server sends a VAL application requirement response to notify on the result of the request and indicate whether the configuration of slice API is possible or not; and (5) The NSCE server sends the slice API information notification to the VAL server.

Regarding configuration updates procedures, a VAL server-initiated configuration update procedure can cover a scenario where a trigger event occurs (e.g., QoS degradation, slice load) and the mapping configuration or the slice API configuration are to be changed. In such scenarios, a slice enabler updates the configuration of the API and provides a notification to the VAL server.

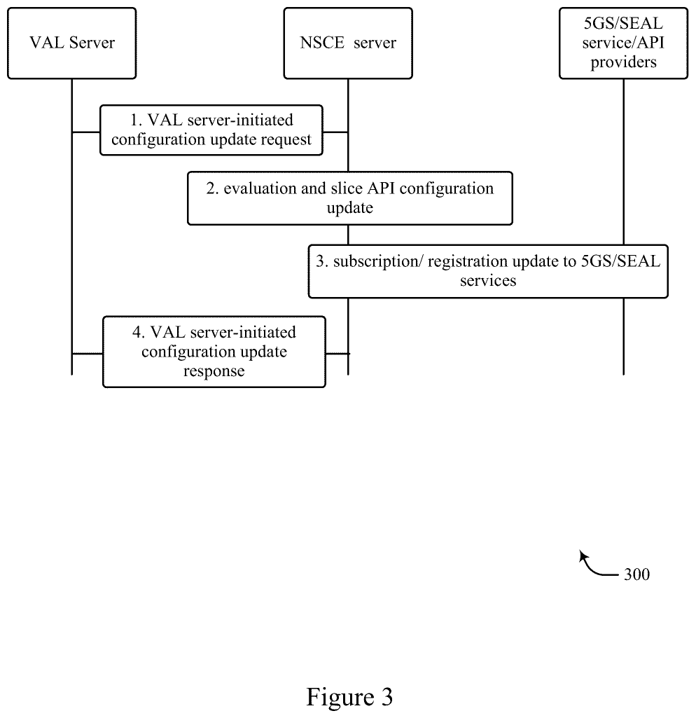

FIG. 3 illustrates an example signaling diagram 300 for slice API configuration update based on a trigger event. The signaling diagram 300, for instance, is based on FIG. 9.3.2.1.3-1 in 3GPP TS 23.435. In the signaling diagram 300: (1) The VAL server sends a VAL server-initiated configuration update request to the NSCE server; (2) The NSCE server processes the trigger event and checks the feasibility of such change and updates the mapping of service APIs to the slice APIs. One criterion for the update of the mapping is to avoid changing the slice API configuration, which can be achieved by the re-mapping of the underlying service APIs; (3) The NSCE server updates the subscription/registration to the underlying 5GS and SEAL service producers, if an update on the service APIs (e.g., NEF APIs, SEAL APIs, OAM provided APIs) is to be performed; and (4) The NSCE server sends a VAL server-initiated configuration update response, including the new slice API information, if an update has been carried out by the NSCE server.

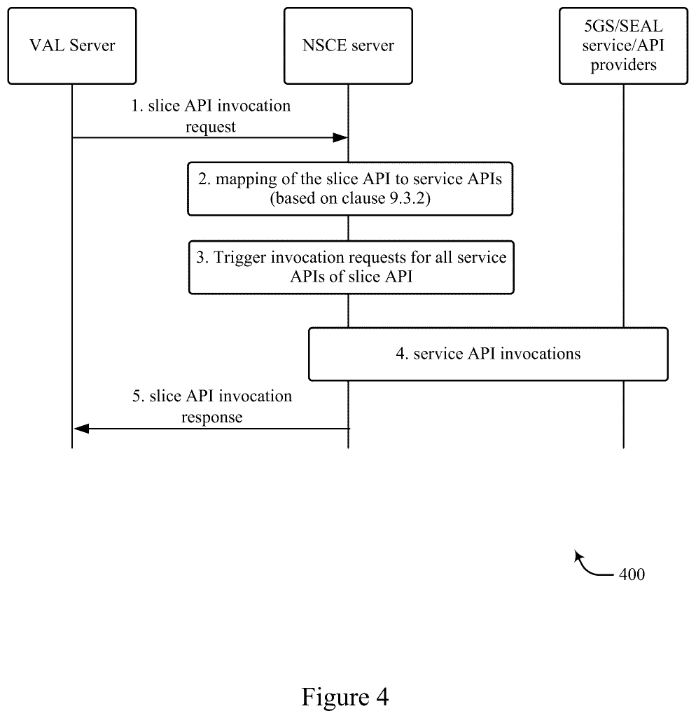

FIG. 4 illustrates an example signaling diagram 400 for slice API translation based on an initial configuration. The signaling diagram 400, for instance, is based on FIG. 9.3.2.2-1 in 3GPP TS 23.435. The signaling diagram 400 describes how a slice API invocation request is translated to service API invocations after the slice API configuration mapping. In the signaling diagram 400, for instance, the NSCE server initially receives a slice API invocation request from the vertical application. Then, the NSCE server fetches the service APIs to be invoked based on the slice API configuration and performs invocation requests to the corresponding service API providers.

In the signaling diagram 400: (1) The VAL server sends a slice API invocation request to the NSCE server; (2) The NSCE server checks that the user is authenticated and authorized to perform the slice API invocation and maps the requested slice API to a service APIs. If Common API Framework (CAPIF) is used, the NSCE server acts as API Exposing Function (AEF), and the authorization is obtained by CAPIF Core Function (CCF); (3) The NSCE server generates a trigger for service API invocation requests to the service APIs within the slice API; (4) The NSCE server performs the corresponding service API invocation procedures based on CAPIF or via performing requests to the corresponding service API providers, which are mapped to the slice API.

If CAPIF is used, the requests are sent to the corresponding AEFs of the API provider's domain, and the authorization is obtained by CCF; and (5) The NSCE server sends a slice API invocation response to the VAL server, based on the result of the service API invocation response(s) of step 4.

Accordingly, the present disclosure provides solutions for different slice API-related services including API configuration, API update, and API invocation.

Regarding slice API configuration, implementations provide a slice API configuration service that can be exposed by an NSCE server. For instance, a NSCE_SliceApiConfiguration service can represent an extension of clause 9.3 of 3GPP TS 23.435. The slice API configuration service can provide various functionality including enabling a service consumer to request to map a VAL application parameter to a slice API for initial slice API configuration, request to update a slice API configuration, and notify the service consumer of an updated slice API configuration.

Table 1 below provides examples operations defined for a slice API configuration service.

TABLE 1
Service Operations for a Slice Configuration Service

| Service Operation Name | Description | Initiated by |
|---|---|---|
| Val_Application_Requirement | This service operation is | VAL Server |
| | used to map the VAL | |
| | application requirement | |
| | to a slice API as a part | |
| | of a service API list. | |
| Val_Configuration_Update | This service operation is | VAL Server |
| | used to update the slice | |
| | API configuration. | |
| Slice_Api_Notify | This service operation is | NSCE |
| | used to provide | Server |
| | information about the | |
| | initial or the updated | |
| | configured slice API. | |

Regarding the service operation Val_Application_Requirement, this service operation can be used by the VAL server to provide the NSCE Server with the VAL application parameter which is to be mapped to a slice API as a part of a service API list. The service API list is used to expose the 5GS/SEAL services by the applications associated to the slice. Upon success or failure of the slice API initial configuration, the NSCE Server can inform the VAL server about the status.

Implementations can request to map a VAL application requirement to a slice API by using Val_Application_Requirement. To configure a slice API with the VAL application requirement, the VAL Server can send an HTTP POST request with a Request-URI according to the pattern “{apiRoot}/nsce-sac/<apiVersion>/reqt” and with a body including data type ReqtReq, such as defined in clause 5.2.6.2.2.

Upon receipt of the HTTP POST request, the NSCE Server can (1) verify the identity of the VAL server and determine if the VAL server is authorized to request for the slice API initial configuration; and (2) if the VAL server (a) is not authorized, the NSCE Server can respond to the VAL server with an appropriate error status code; or (b) the VAL server is authorized, the NSCE Server: (i) can map the VAL application requirement to a slice API which includes a list of APIs, consumed as part of the service capability exposure; and (ii) may store the mapped slice API to the service API list per service API information, and respond to the VAL server with an HTTP “200 OK” status code, with the response body including the ReqtRes data structure (e.g., as defined in clause 5.2.6.2.3) including the result of the slice API configuration and a configuration error.

Regarding the service operation Val_Configuration_Update, this service operation can be used by the VAL server to request the NSCE server to update the slice API configuration. To request to update a slice API configuration by using Val_Configuration_Update, the VAL Server can send an HTTP POST request with a Request-URI according to the pattern “{apiRoot}/nsce-sac/<apiVersion>/UpdReqt” and with a body including data type UpdReq, such as defined in clause 5.2.6.2.4. Upon receipt of the HTTP POST request, the NSCE Server can (1) verify the identity of the VAL server and determine if the VAL server is authorized to update the slice API configuration; and (2) if the VAL server: (a) is not authorized, the NSCE Server can respond to the VAL server with an appropriate error status code; or (b) if the VAL server is authorized, the NSCE Server can: (i) update the mapping of service APIs to the slice API; and (ii) update the subscription or registration to the underlying service, and respond to the VAL server with an HTTP “200 OK” status code, with the response body including the UpdRes data structure (e.g., as defined in clause 5.2.6.2.5) including the result of the updated slice API configuration and the updated slice API information and/or a configuration error.

Regarding the service operation Slice_Api_Notify, this service operation can be used by the NSCE server to notify the VAL server with information of the initial slice API configuration and/or the updated slice API configuration. For instance, to notify with information about a slice API configuration by using Slice_Api_Notify, the NSCE Server can send an HTTP POST request with a Request-URI according to the pattern “{apiRoot}/nsce-sac/<apiVersion>/apiInfo” and with a body including data type ApiInfo, such as defined in clause 5.2.6.2.6. Upon receipt of the HTTP POST request, the VAL Server can respond to NSCE Server with: (1) if the request is successfully processed, a “204 No Content” status code and process the event notification; or (2) if errors occur when processing the request, an appropriate error response, such as specified in clause 5.2.7.

According to implementations a slice API configuration service can use a slice API configuration API. For instance, an NSCE_SliceApiConfiguration service can use a NSCE_SliceApiConfiguration API. In such implementations the request URIs used in HTTP requests from the VAL server towards the NSCE server can have a Resource URI structure (e.g., as defined in clause 5.2.4 of 3GPP TS 29.122) with the following clarifications:
The <apiName> can be “nsce-sac”.
The <apiVersion> can be “v1”.
The <apiSpecificSuffixes> can be set as described in clause 5.2.4.

(Sec 3GPP TS 29.122, Release 18, Version 18.4.0, Dec. 18, 2024, titled “T8 reference point for Northbound APIs,” hereinafter referred to as “3GPP TS 29.122”, which is hereby incorporated by reference herein in its entirety). Regarding usage of HTTP and common API related aspects, the provisions of clause 5.2 of 3GPP TS 29.122 can apply for the NSCE_SliceApiConfiguration API. The following discussion provides example details for structures for resource URIs and the resources and methods that can be used for a slice API configuration API.

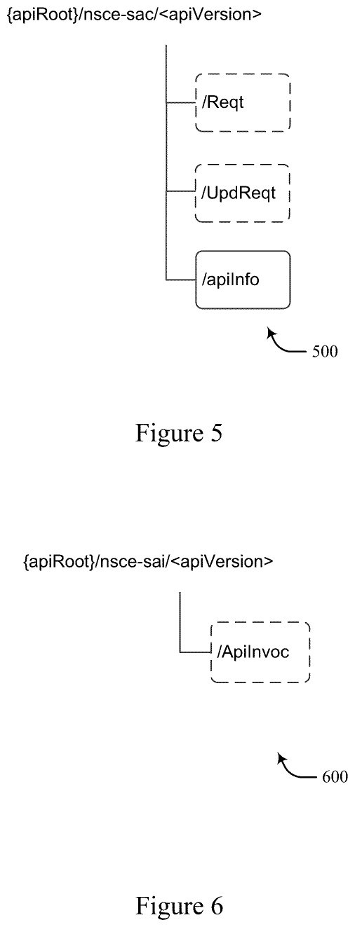

FIG. 5 illustrates an example resource URI structure 500 in accordance with aspects of the present disclosure. The resource URI structure 500, for instance, represents a resource URI structure of an NSCE_SliceApiConfiguration API.

Table 2 below provides an overview of resources and HTTP methods for a slice API configuration API.

TABLE 2
Resources and Methods Overview

| | | HTTP method or | |
|---|---|---|---|
| Resource name | Resource URI | custom operation | Description |
| Slice API | /apiInfo | POST | Provides the slice |
| information | | | API information |
| | | | notification. |

A slice API information resource can be used for a NSCE server to notify a VAL server about the slice API information. An example Resource URI is:
{apiRoot}/nsce-sac/<apiVersion>/apiInfo

A slice API information resource can support resource URI variables such as defined in Table 3, below.

TABLE 3
Resource URI Variables

| Name | Data Type | Definition |
|---|---|---|
| apiRoot | string | See clause 5.2.3 |

A slice API information resource can utilize a POST method which can enable a NSCE server to notify a VAL server with slice API information. This method can support the URI query parameters specified in Table 4, below.

TABLE 4
URI query parameters supported by the POST method
on the Slice API Information Resource

| | | | | |
|---|---|---|---|---|
| Name | Data type | P | Cardinality | Description |

The POST method can support the request data structures specified in Table 5 and the response data structures and response codes specified in Table 6, below.

TABLE 5
Data structures supported by the POST Request
Body on the Slice API Information Resource

| Data type | P | Cardinality | Description |
|---|---|---|---|
| SlApiInfo | M | 1 | Notification on slice API information in: |
| | | | initial configuration procedure; or |
| | | | configuration update procedure. |

TABLE 6
Data structures supported by the POST
Response Body on this resource

| Data type | P | Cardinality | Response codes | Description |
|---|---|---|---|---|
| n/a | | | 204 No Content | Notification for |
| | | | | the slice API |
| | | | | information is |
| | | | | accepted. |

NOTE:
The HTTP error status codes for the HTTP POST method listed in table 5.2.6-1 of 3GPP TS 29.122 may apply.

Implementations also support custom operations without associated resources, such as described in Table 7, below.

TABLE 7
Custom operations without associated resources

| | | Mapped | |
|---|---|---|---|
| Custom | Custom | HTTP | |
| operation name | operation URI | method | Description |
| Requirement | /Reqt | POST | Provides VAL application |
| | | | requirements which are to |
| | | | be mapped to a slice API as |
| | | | a part of a service API list |
| Updated | /UpdReqt | POST | Requests for an update of |
| requirement | | | the slice API configuration. |

The Requirement operation can be used by the VAL server to provide the NSCE server with the VAL application requirement which is to be mapped by the NSCE server to a slice API as a part of a service API list.

The Requirement operation can support the request data structures specified in Table 8 and the response data structures and response codes specified in Table 9, below.

TABLE 8
Data structures supported by the POST Request Body

| Data type | P | Cardinality | Description |
|---|---|---|---|
| ReqtReq | M | 1 | Provides requirement which is to be |
| | | | mapped to a slice API as a part of a slice |
| | | | API list. |

TABLE 9
Data structures supported by the POST Response Body

| | | | Response | |
|---|---|---|---|---|
| Data type | P | Cardinality | codes | Description |
| ReqtRes | M | 1 | 200 OK | The network slice adaptation |
| | | | | request is successfully |
| | | | | received and processed. |

NOTE:
The manadatory HTTP error status codes for the HTTP POST method listed in table 5.2.6-1 of 3GPP TS 29.122 can also apply.

The custom operation Updated requirement can be used by the VAL server to request the NSCE server an update of the slice API configuration. This custom operation can support the request data structures specified in Table 10 the response data structures and response codes specified in Table 11, below.

TABLE 10
Data structures supported by the POST Request Body

| Data type | P | Cardinality | Description |
|---|---|---|---|
| UpdReq | M | 1 | Requests an update of the slice API |
| | | | configuration |

TABLE 11
Data structures supported by the POST Response Body

| | | | Response | |
|---|---|---|---|---|
| Data type | P | Cardinality | codes | Description |
| UpdRes | M | 1 | 200 OK | Whether the result of the |
| | | | | update of the slice API |
| | | | | configuration was successful |
| | | | | or not. |

NOTE:
The manadatory HTTP error status codes for the HTTP POST method listed in table 5.2.6-1 of 3GPP TS 29.122 can also apply.

The following discusses aspects of an application data model supported by the slice configuration API for instance, Table 12 specifies the data types defined for the NSCE_SliceApiConfiguration API.

TABLE 12
NSCE_SliceApiConfiguration API specific Data Types

| | | | |
|---|---|---|---|
| | Clause | | |
| Data type | defined | Description | Applicability |

| | | |
|---|---|---|
| AccToken | 5.2.6.2.9 | Indicates access token |
| | | standard claims, specified |
| | | in 3GPP TS 33.122. |

Table 13 specifies data types re-used by the NSCE_SliceApiConfiguration API from other specifications, including a reference to their respective specifications and optionally, a short description of their use within the NSCE_SliceApiConfiguration API.

TABLE 13
NSCE_SliceApiConfiguration API re-used Data Types

| | | | |
|---|---|---|---|
| Data type | Reference | Comments | Applicability |

| | | |
|---|---|---|
| NetSliceId | 3GPP TS 29.435 | Identifies the Single |
| | | Network Slice |
| | | Selection Assistance |
| | | Information |
| | | (S-NSSAI) |
| TimeWindow | 3GPP TS 29.122 | A time window. |

The following provides a discussion of structures that can be used in resource representations. For instance, Table 14 provides a definition of the type ReqtReq.

TABLE 14
Definition of type ReqtReq

| | | | | | |
|---|---|---|---|---|---|
| Attribute | | | | | |
| name | Data type | P | Cardinality | Description | Applicability |

| | | | | |
|---|---|---|---|---|
| srvReqts | array | M | 1 . . . N | VAL application requirements |
| | (ValSrvReqt) | | | pertaining to one or more slices. |
| timeValidity | TimeWindow | O | 0 . . . 1 | The time validity of the request. |

Note: Data type ValSrvReqt is according to table 9.1.1.2-1 of 3GPP TS 23.435.

Table 15 provides a definition of the type ReqtRes.

TABLE 15
Definition of type ReqtRes

| | | | | | |
|---|---|---|---|---|---|
| Attribute | | | | | |
| name | Data type | P | Cardinality | Description | Applicability |

| | | | | |
|---|---|---|---|---|
| confRslt | boolean | M | 1 | Indicates on the result of the |
| | | | | request for VAL application |
| | | | | requirement that the slice API |
| | | | | configuration: |
| | | | | if set to “1”, is possible; |
| | | | | or |
| | | | | if set to “0”, is not |
| | | | | possible. |
| confErr | ConfErr | O | 0 . . . 1 | Indicates the reason for the |
| | | | | configuration error. |

Table 16 provides a definition of the type UpdReq.

TABLE 16
Definition of type UpdReq

| | | | | | |
|---|---|---|---|---|---|
| Attribute | | | | | |
| name | Data type | P | Cardinality | Description | Applicability |

| | | | | |
|---|---|---|---|---|
| trigEvnt | TrigEvnt | M | 1 | Indicates trigger event causing an |
| | | | | indication for slice API |
| | | | | configuration update. |
| netSliceId | NetSliceId | O | 0 . . . 1 | Identifier of the network slice for |
| | | | | which the API configuration is |
| | | | | requested. |

Table 17 provides a definition of the type UpdRes.

TABLE 17
Definition of type UpdRes

| | | | | | |
|---|---|---|---|---|---|
| Attribute | | | | | |
| name | Data type | P | Cardinality | Description | Applicability |

| | | | | |
|---|---|---|---|---|
| confUpdRslt | boolean | M | 1 | Indicates on the result of the |
| | | | | request for update the slice API |
| | | | | configuration: |
| | | | | if set to “1”, is updated; or |
| | | | | if set to “0”, is not updated. |
| slApiInfoUpd | SlApiInfo | M | 1 | Indicates the updated slice API |
| | | | | information if the slice API |
| | | | | configuration is updated. |
| confErr | ConfErr | O | 0 . . . 1 | Indicates the reason for the |
| | | | | configuration update error if the |
| | | | | slice API configuration is not |
| | | | | updated. |

Table 18 provides a definition of the type ApiInfo.

TABLE 18
Definition of type ApiInfo

| | | | | | |
|---|---|---|---|---|---|
| Attribute | | | | | |
| name | Data type | P | Cardinality | Description | Applicability |

| | | | | |
|---|---|---|---|---|
| slApiInfo | SlApiInfo | M | 1 | Indicates the |
| | | | | slice API |
| | | | | information |

For the slice configuration API (e.g., NSCE_SliceApiConfiguration API), HTTP error responses can be supported as specified in clause 5.2.6 of 3GPP TS 29.122. Protocol errors and application errors specified in clause 5.2.6 of 3GPP TS 29.122 can be supported for the HTTP status codes specified in table 5.2.6-1 of 3GPP TS 29.122.

Further, the requirements in the following clauses are applicable for the slice configuration API.

Application Errors: Example application errors defined for the slice configuration API are listed in Table 19.

TABLE 19
Application errors

| | | | |
|---|---|---|---|
| Application Error | HTTP status code | Description | Applicability |

Table 20 lists example supported features for feature negotiation.

TABLE 20
Supported Features

| | | |
|---|---|---|
| Feature number | Feature Name | Description |

Regarding security the provisions of clause 6 of 3GPP TS 29.122 can apply for the slice configuration API.

The following presents example YAML code for a slice API configuration API, e.g., NSCE_SliceApiConfiguration API.

```
openapi: 3.0.0
info:
  title: NSCE_SliceApiConfiguration
  version: 1.0.0-alpha.1
  description: |
    NSCE Server Slice API Configuration Service.
    © <2024>, 3GPP Organizational Partners (ARIB, ATIS, CCSA, ETSI, TSDSI, TTA,
TTC).
    All rights reserved.
externalDocs:
  description: >
    3GPP TS 29.435 V0.2.0; Service Enabler Architecture Layer for Verticals
  (SEAL);
    NSCE Server Services; Stage 3.
  url: http://www.3gpp.org/ftp/Specs/archive/29_series/29.435/
servers:
  - url: ‘{apiRoot}/nsce-sac/v1’
    variables:
      apiRoot:
        default: https://example.com
        description: apiRoot as defined in clause 6.5 of 3GPP TS 29.549
security:
  - { }
  - oAuth2ClientCredentials: [ ]
paths:
  /Reqt:
    post:
      summary: Slice API configuration maps VAL application to a slice API of
service APIs.
      operationId: SliceAPIConfiguration
      tags:
        - Slice API configuration
      requestBody:
        required: true
        content:
          application/json:
            schema:
              $ref: ‘#/components/schemas/ReqtReq’
      responses:
        ‘200’:
          description: >
            The slice API configuration request has been successfully received
and processed
            and the result of the requested slice API configuration is in the
response body.
          content:
            application/json:
              schema:
                type: array
                items:
                  $ref: ‘#/components/schemas/ReqtRes'
                minItems: 1
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
  /UpdReqt:
    post:
      summary: Update the slice API configuration of the mapping the slice
configuration.
      operationId: UpdateSliceAPIConfiguration
      tags:
        - Update slice API configuration
      requestBody:
        required: true
        content:
          application/json:
            schema:
              $ref: ‘#/components/schemas/UpdReq’
      responses:
        ‘200’:
          description: >
            Update for the slice API configuration request has been successfully
received and
            processed and the result of the requested update for the slice API
configuration
            is in the response body.
          content:
            application/json:
              schema:
                type: array
                items:
                  $ref: ‘#/components/schemas/UpdRes'
                minItems: 1
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
  /apiInfo:
    post:
      summary: Notifies with slice API information.
      operationId: SliceAPIInfoNotification
      tags:
        - Slice API information notification
      requestBody:
        required: true
        content:
          application/json:
            schema:
              $ref: ‘#/components/schemas/SlApiInfo’
      responses:
        ‘204’:
          description: No Content, Notification was succesfull
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml #/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/ responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
components:
  securitySchemes:
    oAuth2ClientCredentials:
      type: oauth2
      flows:
        clientCredentials:
          tokenUrl: ‘{tokenUrl}’
          scopes: { }
  schemas:
#
# STRUCTURED DATA TYPES
#
    ReqtReq:
      description: >
        Represents the slice API configuration request.
      type: object
      properties:
        srvReqts:
          type: array
          items:
          $ref: ‘#/components/schemas/ValSrvReqt’
          minItems: 1
        timeValidity:
          $ref: ‘TS29122_CommonData.yaml#/components/schemas/TimeWindow’
      required:
        - srvReqts
  Note: Data type ValSrvReqt is according to table 9.1.1.2-1 of 3GPP TS 23.435.
    ReqtRes:
      description: >
        Represents result of the successfully processed slice API configuration.
      type: object
      properties:
        confRlt:
          type: boolean
        confErr:
          $ref: ‘#/components/schemas/ConfErr’
      required:
        - confRlt
  Note: Data type can include failure in 5GS/SEAL or other (e.g. server internal error).
    UpdReq:
      description: >
        Represents the slice API configuration update request.
      type: object
      properties:
        trigEvnt:
          $ref: ‘#/components/schemas/TrigEvnt’
        netSliceId:
          $ref:
‘TS29435_NSCE_PolicyManagement.yaml#/components/schemas/NetSliceId’
      required:
        - trigEvnt
    UpdRes:
      description: >
        Represents result of the successfully processed slice API configuration
update.
      type: object
      properties:
        confUpdRslt:
          type: boolean
        slApiInfoUpd:
          $ref: ‘#/components/schemas/SlApiInfo’
        confErr:
          $ref: ‘#/components/schemas/ConfErr’
      required:
        - confUpdRlt
        - slApiInfoUpd
  Note: Data type ConfErr can include no change was needed, failure of changing in 5GS/SEAL, or other (e.g. server
          internal error).
    ApiInfo:
      description: >
        Represents the slice notification information.
      type: object
      properties:
        slApiInfo:
          $ref: ‘#/components/schemas/SlApiInfo’
      required:
        - slApiInfo
```

Regarding slice API invocation, the present disclosure provides a slice API invocation service (e.g., NSCE_SliceApiInvocation service) that enables a service consumer to request a slice API invocation. The slice invocation service (e.g., corresponding to clause 9.3 of 3GPP TS 23.435) can be exposed by the NSCE server.

Table 21 includes examples of service operations defined for a slice API invocation service.

TABLE 21
NSCE_SliceApiInvocation Service Operations

| Service Operation Name | Description | Initiated by |
|---|---|---|
| Slice_Api_Invocation | This service operation is used | VAL Server |
| | for slice API invocation. | |

The Slice_Api_Invocation service operation can be used by the VAL Server to request the NSCE Server for the slice API invocation to be further translated to the service API invocation. To request the slice API invocation, the VAL Server can send an HTTP POST request with a Request-URI (e.g., according to the pattern “{apiRoot}/nsce-sai/<apiVersion>/ApiInvoc”) and with a body including data type InvocReq such as defined in clause 5.2.6.2.2.

Upon receipt of the HTTP POST request, the NSCE Server can: (1) verify the identity of the VAL server and determine if the VAL Server is authorized to request the slice API invocation; and (2) if the VAL server: (a) is not authorized, the NSCE Server can respond to the VAL server with an appropriate error status code; or (b) if the VAL server is authorized, the NSCE Server can: (i) map the requested slice API for invocation to the service APIs for the further translation to the service API invocations; and (ii) perform corresponding service API invocation procedures, and respond to the VAL Server with an HTTP “200 OK” status code, with the response body including the InvocRes data structure including the result of the slice API invocation and/or configuration error.

Implementations provide a slice API invocation API, e.g., NSCE_SliceApiInvocation API. For the slice API invocation API, the request URIs used in HTTP requests from the VAL server towards the NSCE server can have a Resource URI structure (e.g., as defined in clause 5.2.4 of 3GPP TS 29.122) with the following clarifications:
The <apiName> can be “nsce-sai”.
The <apiVersion> can be “v1”.
The <apiSpecificSuffixes> can be set as described in clause 5.2.4.

For usage of HTTP and common API-related aspects the provisions of clause 5.2 of 3GPP TS 29.122 can apply for the slice API invocation API.

FIG. 6 illustrates an example resource URI structure 600 in accordance with aspects of the present disclosure. The resource URI structure 600, for instance, represents a custom operations URI structure of an NSCE_SliceApiInvocation API.

Table 22 illustrates example custom operations associated with a slice API invocation API without associated resources.

TABLE 22
Custom operations without associated resources

| Custom | Custom | Mapped | |
|---|---|---|---|
| operation | operation | HTTP | |
| name | URI | method | Description |
| ApiInvoc | /ApiInvoc | POST | Requests for a slice API |
| | | | invocation. |

The custom operation ApiInvoc can be used by the VAL server to request the NSCE server for slice API invocation.

This custom operation ApiInvoc can support the request data structures specified in Table 23 the response data structures and response codes specified in Table 24.

TABLE 23
Data structures supported by the POST Request Body

| Data type | P | Cardinality | Description |
|---|---|---|---|
| InvocReq | M | 1 | Requests slice API invocation |

TABLE 24
Data structures supported by the POST Response Body

| | | | Response | |
|---|---|---|---|---|
| Data type | P | Cardinality | codes | Description |
| InvocRes | M | 1 | 200 OK | Whether the result of the |
| | | | | slice API invocation |
| | | | | was successful or not. |

NOTE:
The manadatory HTTP error status codes for the HTTP POST method listed in table 5.2.6-1 of 3GPP TS 29.122 can also apply.

The following discusses an application data model supported by the slice API invocation API. For instance, Table 25 specifies data types defined for the NSCE_SliceApiInvocation API.

TABLE 25
NSCE_SliceApiInvocation API specific Data Types

| | | | |
|---|---|---|---|
| | Clause | | |
| Data type | defined | Description | Applicability |

| | | |
|---|---|---|
| AccToken | 5.2.6.2.4 | Indicates access token standard |
| | | claims, specified in |
| | | 3GPP TS 33.122. |

Table 26 specifies data types re-used by the NSCE_SliceApiInvocation API from other specifications, including a reference to their respective specifications and a short description of their use within the NSCE_SliceApiInvocation API.

TABLE 26
NSCE_SliceApiInvocation API re-used Data Types

| | | | |
|---|---|---|---|
| Data type | Reference | Comments | Applicability |

| | | |
|---|---|---|
| NetSliceId | 3GPP TS 29.435 | Identifies the |
| | | S-NSSAI. |

The following discusses structured data types to be used in resource representations. For instance, Table 27 illustrates example definitions of the data type InvocReq, Table 28 illustrates example definitions of the data type InvocRes, and Table 29 illustrates example definitions of the data type AccToken.

TABLE 27
Definition of type InvocReq

| | | | | | |
|---|---|---|---|---|---|
| Attribute | | | | | |
| name | Data type | P | Cardinality | Description | Applicability |

| | | | | |
|---|---|---|---|---|
| netsliceId | NetSliceId | M | 1 | Identifier of the network slice for |
| | | | | which the API invocation is |
| | | | | requested. |
| authInfo | AccToken | O | 0 . . . 1 | Authorization information to |
| | | | | request for the slice API |
| | | | | invocation. |

TABLE 28
Definition of type InvocRes

| | | | | | |
|---|---|---|---|---|---|
| Attribute | | | | | |
| name | Data type | P | Cardinality | Description | Applicability |

| | | | | |
|---|---|---|---|---|
| invocRslt | boolean | M | 1 | Indicates on the result of the |
| | | | | request for slice API invocation |
| | | | | that the slice API invocation: |
| | | | | if set to “1”, is performed; |
| | | | | or |
| | | | | if set to “0”, is not |
| | | | | performed. |
| invocErr | InvocErr | O | 0 . . . 1 | Indicates the reason for the slice |
| | | | | API invocation failure, if it fails. |

TABLE 29
Definition of type AccToken

| | | | | | |
|---|---|---|---|---|---|
| Attribute | | | | | |
| name | Data type | P | Cardinality | Description | Applicability |

| | | | | |
|---|---|---|---|---|
| timeValidity | TimeWindow | M | 1 | Indicates the validity time. |
| srvList | array(string) | M | 1 | Indicates the list of services |
| | | | | the access token is valid. |

Regarding error handling for the NSCE_SliceApiInvocation API, HTTP error responses can be supported as specified in clause 5.2.6 of 3GPP TS 29.122. Protocol errors and application errors specified in clause 5.2.6 of 3GPP TS 29.122 can be supported for the HTTP status codes specified in table 5.2.6-1 of 3GPP TS 29.122. Further, the requirements in the following clauses can be applicable for the NSCE_SliceApiInvocation API.

Application errors defined for the NSCE_SliceApiInvocation API are listed in Table 30 and Table 31 lists supported features for feature negotiation.

TABLE 30
Application errors

| | | | |
|---|---|---|---|
| Application Error | HTTP status code | Description | Applicability |

TABLE 31
Supported Features

| | | |
|---|---|---|
| Feature number | Feature Name | Description |

Regarding security, the provisions of clause 6 of 3GPP TS 29.122 can apply for the NSCE_SliceApiInvocation API.

The following presents example YAML code for a slice invocation API, e.g., NSCE_SliceApiInvocation API.

```
openapi: 3.0.0
info:
  title: NSCE_SliceApiInvocation
  version: 1.0.0-alpha.1
  description: |
    NSCE Server Slice API Invocation Service.
    © <2024>, 3GPP Organizational Partners (ARIB, ATIS, CCSA, ETSI, TSDSI, TTA,
TTC).
    All rights reserved.
externalDocs:
  description: >
    3GPP TS 29.435 V0.2.0; Service Enabler Architecture Layer for Verticals
(SEAL);
    NSCE Server Services; Stage 3.
  url: http://www.3gpp.org/ftp/Specs/archive/29_series/29.435/
servers:
  - url: ‘{apiRoot}/nsce-sai/v1’
    variables:
      apiRoot:
        default: https://example.com
        description: apiRoot as defined in clause 6.5 of 3GPP TS 29.549
security:
  - { }
  - oAuth2ClientCredentials: [ ]
paths:
  /ApiInvoc:
    post:
      summary: Slice API invocation to invoke service APIs based on the slice
API configuration.
      operationId: SliceAPIInvocation
      tags:
        - Slice API invocation
      requestBody:
        required: true
        content:
          application/json:
            schema:
              $ref: ‘#/components/schemas/InvocReq’
      responses:
        ‘200’:
          description: >
            The slice API invocation request has been successfully received and
processed
            and the result of the requested slice API invocation is in the
response body.
          content:
            application/json:
              schema:
                type: array
                items:
                  $ref: ‘#/components/schemas/InvocRes'
                minItems: 1
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
components:
  securitySchemes:
    oAuth2ClientCredentials:
      type: oauth2
      flows:
        clientCredentials:
          tokenUrl: ‘{tokenUrl}’
          scopes: { }
  schemas:
#
# STRUCTURED DATA TYPES
#
    InvocReq:
      description: >
        Represents the slice API invocation request.
      type: object
      properties:
        netSliceId:
          $ref:
‘TS29435_NSCE_PolicyManagement.yaml#/components/schemas/NetSliceId’
        authInfo:
          $ref: ‘#/components/schemas/AccToken’
      required:
        - netSliceId
    InvocRes:
      description: >
        Represents result of the successfully processed slice API invocation
request.
      type: object
      properties:
        invocRslt:
          type: boolean
        invocErr:
          $ref: ‘#/components/schemas/InvocErr’
      required:
        - invocRslt
    AccToken:
      description: >
        Represents the authorization token for services.
      type: object
      properties:
        timeValidity:
          $ref: ‘TS29122_CommonData.yaml#/components/schemas/TimeWindow’
        srvList:
          type: array
          items:
            type: string
          minItems: 1
          description: List of service identifiers.
      required:
        - timeValidity
        - srvList:
```

The present disclosure also provides an integrated API for slice configuration and slice invocation (e.g., translation), which in some implementations can be referred to as a NSCE_SliceApiManagement API. For instance, a slice API management service can be exposed by an NSCE server and can enable a service consumer to request to map a VAL application requirement to a slice API for initial slice API configuration, request to update a slice API configuration, request for a slice API invocation, and notify the service consumer of an updated slice API configuration.

Regarding service operations for a slice API management service, Table 32 lists example service operations defined for the NSCE_SliceApiManagement service.

TABLE 32
NSCE_SliceApiManagement Service Operations

| Service Operation Name | Description | Initiated by |
|---|---|---|
| Val_Application_Requirement | This service operation is used to map the | VAL Server |
| | VAL application requirement to a slice API | |
| | as a part of a service API list. | |
| Val_Configuration_Update | This service operation is used to update the | VAL Server |
| | slice API configuration. | |
| Slice_Api_Notify | This service operation is used to provide | NSCE Server |
| | information about the initial or the updated | |
| | configured slice API. | |
| Slice_Api_Invocation | This service operation is used for slice API | VAL Server |
| | invocation. | |

The following discusses aspects of the example service operations of the NSCE_SliceApiManagement service.

The Val_Application_Requirement can be used by the VAL server to provide the NSCE Server the VAL application requirement which is to be mapped to a slice API as a part of a service API list. The service API list is used to expose the 5GS/SEAL services by the applications associated to the slice. Upon success or failure of the slice API initial configuration, the NSCE Server can inform the VAL server about the status.

To configure the slice API with the VAL application requirement, the VAL Server can send an HTTP POST request with a Request-URI according to the pattern “{apiRoot}/nsce-sam/<apiVersion>/Reqt” and with a body including data type ReqtReq.

Upon receipt of the HTTP POST request, the NSCE Server can: (1) verify the identity of the VAL server and determine if the VAL server is authorized to request for the slice API initial configuration; and (2) if the VAL server: (a) is not authorized, the NSCE Server can respond to the VAL server with an appropriate error status code; or (b) if the VAL server is authorized, the NSCE Server: (i) can map the VAL application requirement to a slice API which includes a list of APIs, consumed as part of the service capability exposure; and (ii) may store the mapped slice API to the service API list per service API information, and respond to the VAL server with an HTTP “200 OK” status code, with the response body including a ReqtRes data structure as defined herein, including the result of the slice API configuration and/or a possible configuration error.

The Val_Configuration_Update service operation can be used by the VAL server to request the NSCE server to update the slice API configuration. For instance, to update the slice API configuration, the VAL Server can send an HTTP POST request with a Request-URI according to the pattern “{apiRoot}/nsce-sam/<apiVersion>/UpdReqt” and with a body including data type UpdReq. Upon receipt of the HTTP POST request, the NSCE Server can: (1) verify the identity of the VAL server and determine if the VAL server is authorized to update the slice API configuration; and (2) if the VAL server: (a) is not authorized, the NSCE Server can respond to the VAL server with an appropriate error status code; or (b) is authorized, the NSCE Server, if feasible, can: (i) update the mapping of service APIs to the slice API; and (ii) update the subscription or registration to the underlying service, and respond to the VAL server with an HTTP “200 OK” status code, with the response body including the UpdRes data structure such as defined herein, including the result of the updated slice API configuration and the updated slice API information and/or a possible configuration error.

The Slice_Api_Notify service operation can be used by the NSCE server to notify the VAL server with information of the initial slice API configuration or the updated slice API configuration. To notify the VAL server with the information about the slice API configuration, the NSCE Server can send an HTTP POST request with a Request-URI according to the pattern “{apiRoot}/nsce-sam/<apiVersion>/apiInfo” and with a body including data type ApiInfo such as defined herein. Upon receipt of the HTTP POST request, the VAL Server can respond to NSCE Server can: (1) if the request is successfully processed, a “204 No Content” status code and process the event notification; or (2) if errors occur when processing the request, an appropriate error response such as specified herein.

The Slice_Api_Invocation service operation can be used by the VAL Server to request the NSCE Server for the slice API invocation and further translation to the service API invocation. To request the slice API invocation, the VAL Server can send an HTTP POST request with a Request-URI according to the pattern “{apiRoot}/nscc-sam/<apiVersion>/ApiInvoc” and with a body including data type InvocReq such as defined herein. Upon receipt of the HTTP POST request, the NSCE Server can: (1) verify the identity of the VAL server and determine if the VAL Server is authorized to request the slice API invocation; and (2) if the VAL server: (a) is not authorized, the NSCE Server can respond to the VAL server with an appropriate error status code; or (b) if the VAL server is authorized, the NSCE Server, can: (i) map the requested slice API for invocation to the service APIs for the further translation to the service API invocations; and (ii) perform the corresponding service API invocation procedures, and respond to the VAL Server with an HTTP “200 OK” status code, with the response body including the InvocRes data structure as defined herein including the result of the slice API invocation and/or a possible configuration error.

According to implementations a slice API management service can a slice API management API. For instance, the NSCE_SliceApiManagement service can use the NSCE_SliceApiManagement API. In implementations the request URIs used in HTTP requests from the VAL server towards the NSCE server can use the Resource URI structure as defined in clause 5.2.4 of 3GPP TS 29.122 with the following clarifications:
The <apiName> can be “nsce-sam”.
The <apiVersion> can be “v1”.
The <apiSpecificSuffixes> can be set as described in clause 5.3.3.

Regarding usage of HTTP and common API related aspects, the provisions of clause 5.2 of 3GPP TS 29.122 can apply for the NSCE_SliceApiManagement API.

The following discussion presents the structure for the Resource URIs and the resources and methods used for the slice API management service.

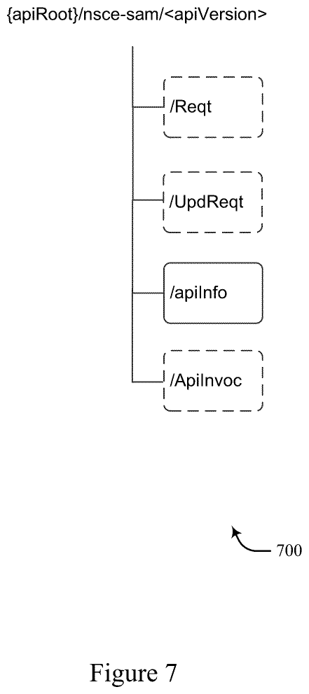

FIG. 7 illustrates an example resource URI structure 700 in accordance with aspects of the present disclosure. The resource URI structure 700, for instance, represents a custom operation URI structure of the NSCE_SliceApiManagement API. Table 33 provides an overview of the resources and applicable HTTP methods for the NSCE_SliceApiManagement API.

TABLE 33
Resources and methods overview

| | | HTTP | |
|---|---|---|---|
| | | method or | |
| | | custom | |
| Resource name | Resource URI | operation | Description |
| Slice API information | /apiInfo | POST | Provides the slice |
| | | | API information |
| | | | notification. |

The Slice API information resource can be used for a NSCE server to notify a VAL server about the slice API information. An example resource URI is:
{apiRoot}/nsce-sam/<apiVersion>/apiInfo

The Slice API information resource can support resource URI variables such as defined in Table 34.

TABLE 34
Resource URI variables

| | | |
|---|---|---|
| Name | Data Type | Definition |

| | |
|---|---|
| apiRoot | string |

The Slice API information resource can utilize a POST method with can enable a NSCE server to notify the VAL server with the slice API information. This method can support the URI query parameters specified in Table 35.

TABLE 35
URI query parameters supported by the POST method

| | | | | |
|---|---|---|---|---|
| Name | Data type | P | Cardinality | Description |

Further, the POST method can support the request data structures specified in Table 36 and the response data structures and response codes specified in Table 37.

TABLE 36
Data structures supported by the POST Request Body

| Data type | P | Cardinality | Description |
|---|---|---|---|
| SlApiInfo | M | 1 | Notification on slice API information |
| | | | in: |
| | | | initial configuration |
| | | | procedure; or |
| | | | configuration update |
| | | | procedure. |

TABLE 37
Data structures supported by the POST Response Body

| | | | Response | |
|---|---|---|---|---|
| Data type | P | Cardinality | codes | Description |
| n/a | | | 204 No Content | Notification for |
| | | | | the slice API |
| | | | | information is |
| | | | | accepted. |

NOTE:
The HTTP error status codes for the HTTP POST method listed in table 5.2.6-1 of 3GPP TS 29.122 can also apply.

Table 38 lists example custom operations without associated resources.

TABLE 38
Custom operations without associated resources

| Custom | Custom | Mapped | |
|---|---|---|---|
| operation | operation | HTTP | |
| name | URI | method | Description |
| VAL | /Reqt | POST | Provides VAL application |
| application | | | requirements which are to be |
| Requirement | | | mapped to a slice API as a |
| | | | part of a service API list |
| Updated VAL | /UpdReqt | POST | Requests for an update of |
| application | | | the slice API configuration. |
| requirement | | | |
| Slice API | /ApiInvoc | POST | Requests for a slice API |
| invocation | | | invocation. |

The VAL application Requirement represents a custom operation that can be used by the VAL server to provide the NSCE server with the VAL application requirement which is to be mapped by the NSCE server to a slice API as a part of a service API list. The VAL application Requirement can support the request data structures specified in Table 39 the response data structures and response codes specified in Table 40.

TABLE 39
Data structures supported by the POST Request Body

| Data type | P | Cardinality | Description |
|---|---|---|---|
| ReqtReq | M | 1 | Provides requirement which is |
| | | | to be mapped to a slice API as |
| | | | a part of a slice API list. |

TABLE 40
Data structures supported by the POST Response Body

| | | | Response | |
|---|---|---|---|---|
| Data type | P | Cardinality | codes | Description |
| ReqtRes | M | 1 | 200 OK | The network slice adaptation |
| | | | | request is successfully |
| | | | | received and processed. |

NOTE:
The HTTP error status codes for the HTTP POST method listed in table 5.2.6-1 of 3GPP TS 29.122 can also apply.

The Updated VAL application requirement custom operation can be used by the VAL server to request the NSCE server an update of the slice API configuration. This custom operation can support the request data structures specified in Table 41 the response data structures and response codes specified in Table 42.

TABLE 41
Data structures supported by the POST Request Body

| Data type | P | Cardinality | Description |
|---|---|---|---|
| UpdReq | M | 1 | Requests an update of the slice |
| | | | API configuration |

TABLE 42
Data structures supported by the POST Response Body

| Data | | | Response | |
|---|---|---|---|---|
| type | P | Cardinality | codes | Description |
| UpdRes | M | 1 | 200 OK | Whether the result of the update |
| | | | | of the slice API configuration |
| | | | | was successful or not. |

NOTE:
The HTTP error status codes for the HTTP POST method listed in table 5.2.6-1 of 3GPP TS 29.122 can also apply.

The Slice API invocation application requirement custom operation can be used by the VAL server to request the NSCE server for slice API invocation. This custom operation can support the request data structures specified in Table 43 the response data structures and response codes specified in Table 44.

TABLE 43
Data structures supported by the POST Request Body

| Data type | P | Cardinality | Description |
|---|---|---|---|
| InvocReq | M | 1 | Requests slice API invocation |

TABLE 44
Data structures supported by the POST Response Body

| Data | | | Response | |
|---|---|---|---|---|
| type | P | Cardinality | codes | Description |
| InvocRes | M | 1 | 200 OK | Whether the result of the slice |
| | | | | API invocation was successful |
| | | | | or not. |

NOTE:
The manadatory HTTP error status codes for the HTTP POST method listed in table 5.2.6-1 of 3GPP TS 29.122 can also apply.

Regarding the application data model supported by the slice management API, Table 45 specifies the data types defined for the NSCE_SliceApiManagement API and Table 46 specifies data types re-used by the NSCE_SliceApiManagement API from other specifications, including a reference to their respective specifications and a short description of their use within the NSCE_SliceApiManagement API.

TABLE 45
NSCE_SliceApiManagement API specific Data Types

| | | | |
|---|---|---|---|
| Data | Clause | | Applica- |
| type | defined | Description | bility |

| | | |
|---|---|---|
| AccToken | 5.3.6.2.9 | Indicates access token standard |
| | | claims, specified in 3GPP TS 33.122. |

TABLE 46
NSCE_SliceApiManagement API re-used Data Types

| | | | |
|---|---|---|---|
| Data type | Reference | Comments | Applicability |

| | | |
|---|---|---|
| NetSliceId | 3GPP TS 29.435 | Identifies the |
| | | S-NSSAI. |
| TimeWindow | 3GPP TS 29.122 | A time window. |
| Uri | 3GPP TS 29.122 | Represents a URI. |

The following discussion details structured data types for use in resource representations including ReqtReq detailed in Table 47, ReqtRes detailed in Table 48, UpdReq detailed in Table 49, UpdRes detailed in Table 50, ApiInfo detailed in Table 51, InvocReq detailed in Table 52, InvocRes detailed in Table 53, and AccToken detailed in Table 54.

TABLE 47
Definition of type ReqtReq

| | | | | | |
|---|---|---|---|---|---|
| Attribute | | | | | |
| name | Data type | P | Cardinality | Description | Applicability |

| | | | | |
|---|---|---|---|---|
| srvReqts | array(ValSrvReqt) | M | 1 . . . N | VAL application requirements |
| | | | | pertaining to one or more slices. |
| timeValidity | TimeWindow | O | 0 . . . 1 | The time validity of the request. |

TABLE 48
Definition of type ReqtRes

| | | | | | |
|---|---|---|---|---|---|
| Attribute | | | | | |
| name | Data type | P | Cardinality | Description | Applicability |

| | | | | |
|---|---|---|---|---|
| confRslt | boolean | M | 1 | Indicates on the result of the |
| | | | | request for VAL application |
| | | | | requirement that the slice API |
| | | | | configuration: |
| | | | | if set to “1”, is possible; or |
| | | | | if set to “0”, is not |
| | | | | possible. |
| confErr | ConfErr | O | 0 . . . 1 | Indicates the reason for the |
| | | | | configuration error. |

TABLE 49
Definition of type UpdReq

| | | | | | |
|---|---|---|---|---|---|
| Attribute | | | | | |
| name | Data type | P | Cardinality | Description | Applicability |

| | | | | |
|---|---|---|---|---|
| trigEvnt | TrigEvnt | M | 1 | Indicates trigger event causing an |
| | | | | indication for slice API |
| | | | | configuration update. |
| netSliceId | NetSliceId | O | 0 . . . 1 | Identifier of the network slice for |
| | | | | which the API configuration is |
| | | | | requested. |

TABLE 50
Definition of type UpdRes

| | | | | | |
|---|---|---|---|---|---|
| Attribute | | | | | |
| name | Data type | P | Cardinality | Description | Applicability |

| | | | | |
|---|---|---|---|---|
| confUpd | boolean | M | 1 | Indicates on the result of the |
| | | | | request for update the slice API |
| | | | | configuration: |
| | | | | if set to “1”, is updated; or |
| | | | | if set to “0”, is not updated. |
| slApiInfoUpd | SlApiInfo | M | 1 | Indicates the updated slice API |
| | | | | information if the slice API |
| | | | | configuration is updated. |
| confErr | ConfErr | O | 0 . . . 1 | Indicates the reason for the |
| | | | | configuration update error if the |
| | | | | slice API configuration is not |
| | | | | updated. |

TABLE 51
Definition of type ApiInfo

| | | | | | |
|---|---|---|---|---|---|
| Attribute | Data | | | | Applica- |
| name | type | P | Cardinality | Description | bility |

| | | | | |
|---|---|---|---|---|
| slApiInfo | SlApiInfo | M | 1 | Indicates the slice |
| | | | | API information |

TABLE 52
Definition of type InvocReq

| | | | | | |
|---|---|---|---|---|---|
| Attribute | | | | | |
| name | Data type | P | Cardinality | Description | Applicability |

| | | | | |
|---|---|---|---|---|
| netsliceId | NetSliceIdi | M | 1 | Identifier of the network slice for |
| | | | | which the API invocation is |
| | | | | requested. |
| authInfo | AccToken | O | 0 . . . 1 | Authorization information to |
| | | | | request for the slice API |
| | | | | invocation. |

TABLE 53
Definition of type InvocRes

| | | | | | |
|---|---|---|---|---|---|
| Attribute | | | | | |
| name | Data type | P | Cardinality | Description | Applicability |

| | | | | |
|---|---|---|---|---|
| invocRslt | boolean | M | 1 | Indicates on the result of the |
| | | | | request for slice API invocation |
| | | | | that the slice API invocation: |
| | | | | if set to “1”, is performed; |
| | | | | or |
| | | | | if set to “0”, is not |
| | | | | performed. |
| invocErr | InvocErr | O | 0 . . . 1 | Indicates the reason for the slice |
| | | | | API invocation failure, if it fails. |

TABLE 54
Definition of type AccToken

| | | | | | |
|---|---|---|---|---|---|
| Attribute | | | | | |
| name | Data type | P | Cardinality | Description | Applicability |

| | | | | |
|---|---|---|---|---|
| timeValidity | TimeWindow | M | 1 | Indicates the validity time. |
| srvList | SrvList | M | array(string) | Indicates the list of services the |
| | | | | access token is valid. |

For the NSCE_SliceApiManagement API, HTTP error responses can be supported as specified in clause 5.2.6 of 3GPP TS 29.122. Protocol errors and application errors specified in clause 5.2.6 of 3GPP TS 29.122 can be supported for the HTTP status codes specified in table 5.2.6-1 of 3GPP TS 29.122. In addition, the requirements in the following clauses can be applicable for the NSCE_SliceApiManagement API.

Example application errors defined for the NSCE_SliceApiManagement API are listed in Table 55 and supported features for feature negotiation are listed in Table 56.

TABLE 55
Application errors

| | | | |
|---|---|---|---|
| Application Error | HTTP status code | Description | Applicability |

TABLE 56
Supported Features

| | | |
|---|---|---|
| Feature number | Feature Name | Description |

Regarding security, the provisions of clause 6 of 3GPP TS 29.122 can apply for the NSCE_SliceApiManagement API.

The following presents example YAML code for a slice API management API, e.g., NSCE_SliceApiManagement API.

```
openapi: 3.0.0
info:
  title: NSCE_SliceApiManagement
  version: 1.0.0-alpha.1
  description: |
    NSCE Server Slice API Management Service.
    © <2024>, 3GPP Organizational Partners (ARIB, ATIS, CCSA, ETSI, TSDSI, TTA,
TTC).
    All rights reserved.
externalDocs:
  description: >
    3GPP TS 29.435 V0.2.0; Service Enabler Architecture Layer for Verticals
(SEAL);
    NSCE Server Services; Stage 3.
  url: http://www.3gpp.org/ftp/Specs/archive/29_series/29.435/
servers:
  - url: ‘{apiRoot}/nsce-sac/v1’
    variables:
      apiRoot:
        default: https://example.com
        description: apiRoot as defined in clause 6.5 of 3GPP TS 29.549
security:
  - { }
  - oAuth2ClientCredentials: [ ]
paths:
  /Reqt:
    post:
      summary: Slice API configuration maps VAL application to a slice API of
service APIs.
      operationId: SliceAPIConfiguration
      tags:
        - Slice API configuration
      requestBody:
        required: true
        content:
          application/json:
            schema:
              $ref: ‘#/components/schemas/ReqtReq’
      responses:
        ’200’:
          description: >
            The slice API configuration request has been successfully received
and processed
            and the result of the requested slice API configuration is in the
response body.
          content:
            application/json:
              schema:
                type: array
                items:
                  $ref: ‘#/components/schemas/ReqtRes'
                minItems: 1
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
  /UpdReqt:
    post:
      summary: Update the slice API configuration of the mapping the slice
configuration.
      operationId: UpdateSliceAPIConfiguration
      tags:
        - Update slice API configuration
      requestBody:
        required: true
        content:
          application/json:
            schema:
              $ref: ‘#/components/schemas/UpdReq’
      responses:
        ‘200’:
          description: >
            Update for the slice API configuration request has been successfully
received and
            processed and the result of the requested update for the slice API
configuration
            is in the response body.
          content:
            application/json:
              schema:
                type: array
                items:
                  $ref: ‘#/components/schemas/UpdRes'
                minItems: 1
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
  /apiInfo:
    post:
      summary: Notifies with slice API information.
      operationId: SliceAPIInfoNotification
      tags:
        - Slice API information notification
      requestBody:
        required: true
        content:
          application/json:
            schema:
              $ref: ‘#/components/schemas/SlApiInfo’
      responses:
        ‘204’:
          description: No Content, Notification was succesfull
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ‘413’:
          $ref: ‘TS29122_CommonData.yaml#/components/responses/413’
        ‘415’:
          $ref: ‘TS29122_CommonData.yaml#/components/responses/415’
        ‘429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
  /ApiInvoc
    post:
      summary: Slice API invocation to invoke service APIs based on the slice
API configuration.
      operationId: SliceAPIInvocation
      tags:
        - Slice API invocation
      requestBody:
        required: true
        content:
          application/json:
            schema:
              $ref: ‘#/components/schemas/InvocReq’
      responses:
        ‘200’:
          description: >
            The slice API invocation request has been successfully received and
processed
            and the result of the requested slice API invocation is in the
response body.
          content:
            application/json:
              schema:
                type: array
                items:
                  $ref: ‘#/components/schemas/InvocRes'
                minItems: 1
        ‘307’:
          $ref: ‘TS29122_CommonData.yaml#/components/responses/307’
        ‘308’:
          $ref: ‘TS29122_CommonData.yaml#/components/responses/308’
        ‘400’:
          $ref: ‘TS29122_CommonData.yaml#/components/responses/400’
        ‘401’:
          $ref: ‘TS29122_CommonData.yaml#/components/responses/401’
        ‘403’:
          $ref: ‘TS29122_CommonData.yaml#/components/responses/403’
        ‘404’:
          $ref: ‘TS29122_CommonData.yaml#/components/responses/404’
        ‘411’:
          $ref: ‘TS29122_CommonData.yaml#/components/responses/411’
        ’413’:
          $ref: ‘TS29122_CommonData.yaml#/components/responses/413’
        ’415’:
          $ref: ‘TS29122_CommonData.yaml#/components/responses/415’
        ’429’:
          $ref: ‘TS29122_CommonData.yaml#/components/responses/429’
        ‘500’:
          $ref: ‘TS29122_CommonData.yaml#/components/responses/500’
        ‘503’:
          $ref: ‘TS29122_CommonData.yaml#/components/responses/503’
        default:
          $ref: ‘TS29122_CommonData.yaml#/components/responses/default’
components:
  securitySchemes:
    oAuth2ClientCredentials:
      type: oauth2
      flows:
        clientCredentials:
          tokenUrl: ‘{tokenUrl}’
          scopes: { }
  schemas:
#
# STRUCTURED DATA TYPES
#
    ReqtReq:
      description: >
        Represents the slice API configuration request.
      type: object
      properties:
        srvReqts:
          type: array
          items:
          $ref: ‘#/components/schemas/ValSrvReqt’
          minItems: 1
        timeValidity:
          $ref: ‘TS29122_CommonData.yaml#/components/schemas/TimeWindow’
      required:
        - srvReqts
    ReqtRes:
      description: >
        Represents result of the successfully processed slice API configuration.
      type: object
      properties:
        confRlt:
          type: boolean
        confErr:
          $ref: ‘#/components/schemas/ConfErr’
      required:
        - confRlt
    UpdReq:
      description: >
        Represents the slice API configuration update request.
      type: object
      properties:
        trigEvnt:
          $ref: ‘#/components/schemas/TrigEvnt’
        netSliceId:
          $ref:
‘TS29435_NSCE_PolicyManagement.yaml#/components/schemas/NetSliceId’
      required:
        - trigEvnt
    UpdRes:
      description: >
        Represents result of the successfully processed slice API configuration
update.
      type: object
      properties:
        confUpdRslt:
          type: boolean
        slApiInfoUpd:
          $ref: ‘#/components/schemas/SlApiInfo’
        confErr:
          $ref: ‘#/components/schemas/ConfErr’
      required:
        - confUpdRlt
        - slApiInfoUpd
    ApiInfo:
      description: >
        Represents the slice notification information.
      type: object
      properties:
        slApiInfo:
          $ref: ‘#/components/schemas/SlApiInfo’
      required:
        - slApiInfo
    InvocReq:
      description: >
        Represents the slice API invocation request.
      type: object
      properties:
        netSliceId:
          $ref:
‘TS29435_NSCE_PolicyManagement.yaml#/components/schemas/NetSliceId’
        authInfo:
          $ref: ‘#/components/schemas/AccToken’
      required:
        - netSliceId
    InvocRes:
      description: >
        Represents result of the successfully processed slice API invocation
request.
      type: object
      properties:
        invocRslt:
          type: boolean
        invocErr:
          $ref: ‘#/components/schemas/InvocErr’
      required:
        - invocRslt
    AccToken:
      description: >
        Represents the authorization token for services.
      type: object
      properties:
        timeValidity:
          $ref: ‘TS29122_CommonData.yaml#/components/schemas/TimeWindow’
        srvList:
          type: array
          items:
            type: string
          minItems: 1
          description: List of service identifiers.
      required:
        - timeValidity
        - srvList:
```

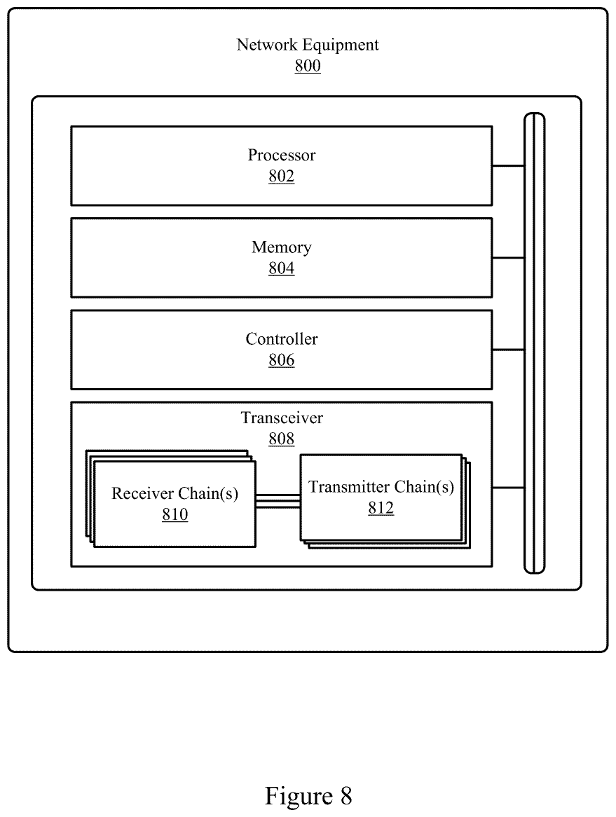

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces. The NE 800 can represent various devices such as a VAL server, an NSCE server, 5GS, SEAL service, API providers, etc.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

The NE 800 may be configured to or operable to support a means for transmitting, to a second NE, a request message for a service operation, the request message including a resource URI for a HTTP POST method, and the service operation including one of an initial API configuration or an API configuration update; and receiving, from the second NE, a response message including a result of the service operation.

Additionally, the NE 800 may be configured to or operable to support any one or combination of where the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; In some aspects, the techniques described herein relate to a method, further including receiving, from the second NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

Additionally, or alternatively, the NE 800 may support at least one memory (e.g., the memory 804) and at least one processor (e.g., the processor 802) coupled with the at least one memory and configured to cause the NE to transmit, to a second NE, a request message for a service operation, the request message including a resource URI for a HTTP POST method, and the service operation including one of an initial API configuration or an API configuration update; and receive, from the second NE, a response message including a result of the service operation.

Additionally, the NE 800 may be configured to support any one or combination of where the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; the at least one processor is configured to cause the first NE to receive, from the second NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

The NE 800 may be configured to or operable to support a means for receiving, from a first NE, a request message for a service operation, the request message including a resource URI for a HTTP POST method, and the service operation including one of an initial API configuration or an API configuration update; performing the service operation; and transmitting, to the first NE, a response message including a result of the service operation.

Additionally, the NE 800 may be configured to or operable to support any one or combination of where the request message further includes one or more data types for the request message; the one or more data types include information pertaining to one or more of the initial API configuration of the API configuration update; the operation URI includes one or more of {apiRoot}/nscc-sac/<apiVersion>/Reqt or {apiRoot}/nsce-sac/<apiVersion>/UpdReqt; In some aspects, the techniques described herein relate to a method, further including transmitting, to the first NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

Additionally, or alternatively, the NE 800 may support at least one memory (e.g., the memory 804) and at least one processor (e.g., the processor 802) coupled with the at least one memory and configured to cause the NE to receive, from a first NE, a request message for a service operation, the request message including a resource URI for a HTTP POST method, and the service operation including one of an initial API configuration or an API configuration update; perform the service operation; and transmit, to the first NE, a response message including a result of the service operation.

Additionally, the NE 800 may be configured to support any one or combination of where the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; the at least one processor is configured to cause the second NE to transmit, to the first NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

The NE 800 may be configured to or operable to support a means for transmitting, to a second NE, a request message for a service operation, the request message including a resource URI for a HTTP POST method, and the service operation including an API invocation associated with an API provider; and receiving, from the second NE, a response message including a result of the service operation.

Additionally, the NE 800 may be configured to or operable to support any one or combination of where the request message further includes one or more data types for the request message; the one or more data types include information pertaining to one or more of an identifier for a network slice for which the API invocation is requested or authorization information for the API invocation; the operation URI includes {apiRoot}/nsce-sai/<apiVersion>/ApiInvoc; the first NE includes a VAL server; the second NE includes a NSCE Server; the service operation pertains to invocation of one or more network slice APIs; the response message includes one or more of a result of the API invocation or an indication of one or more configuration errors.

Additionally, or alternatively, the NE 800 may support at least one memory (e.g., the memory 804) and at least one processor (e.g., the processor 802) coupled with the at least one memory and configured to cause the NE to transmit, to a second NE, a request message for a service operation, the request message including a resource URI for a HTTP POST method, and the service operation including an API invocation associated with an API provider; and receive, from the second NE, a response message including a result of the service operation.

Additionally, the NE 800 may be configured to support any one or combination of where the request message further includes one or more data types for the request message; the one or more data types include information pertaining to one or more of an identifier for a network slice for which the API invocation is requested or authorization information for the API invocation; the operation URI includes {apiRoot}/nsce-sai/<apiVersion>/ApiInvoc; the first NE includes a VAL server; the second NE includes a NSCE Server; the service operation pertains to invocation of one or more network slice APIs; the response message includes one or more of a result of the API invocation or an indication of one or more configuration errors.

The NE 800 may be configured to or operable to support a means for receiving, from a first NE, a request message for a service operation, the request message including a resource URI for a HTTP POST method, and the service operation including an API invocation associated with an API provider; performing the service operation; and transmitting, to the first NE, a response message including a result of the service operation.

Additionally, the NE 800 may be configured to or operable to support any one or combination of where the request message further includes one or more data types for the request message; the one or more data types include information pertaining to one or more of an identifier for a network slice for which the API invocation is requested or authorization information for the API invocation; In some aspects, the techniques described herein relate to a method, further including one or more of: verifying, based at least in part on the information of the one or more data types, an identity of the first NE; or determining, based at least in part on the information of the one or more data types, whether the first NE is authorized to request the API invocation; the response message includes {apiRoot}/nsce-sai/<apiVersion>/ApiInvoc; performing the service operation includes translating the API invocation to a service API invocation; translating the API invocation to the service API invocation includes mapping a network slice for the API invocation to the service API; the first NE includes a VAL server; the second NE includes a NSCE Server; the service operation pertains to invocation of one or more network slice APIs; the response message includes one or more of a result of the API invocation or an indication of one or more configuration errors.

Additionally, or alternatively, the NE 800 may support at least one memory (e.g., the memory 804) and at least one processor (e.g., the processor 802) coupled with the at least one memory and configured to cause the NE to receive, from a first NE, a request message for a service operation, the request message including a resource URI for a HTTP POST method, and the service operation including an API invocation associated with an API provider; perform the service operation; and transmit, to the first NE, a response message including a result of the service operation.

Additionally, the NE 800 may be configured to support any one or combination of where the request message further includes one or more data types for the request message; the one or more data types include information pertaining to one or more of an identifier for a network slice for which the API invocation is requested or authorization information for the API invocation; the at least one processor is configured to cause the second NE to one or more of: verify, based at least in part on the information of the one or more data types, an identity of the first NE; or determine, based at least in part on the information of the one or more data types, whether the first NE is authorized to request the API invocation; the response includes {apiRoot}/nsce-sai/<apiVersion>/ApiInvoc; to perform the service operation, the at least one processor is configured to cause the second NE to translate the API invocation to a service API invocation; to translate the API invocation to the service API invocation, the at least one processor is configured to cause the second NE to map a network slice for the API invocation to the service API; the first NE includes a VAL server; the second NE includes a NSCE Server; the service operation pertains to invocation of one or more network slice APIs; the response message includes one or more of a result of the API invocation or an indication of one or more configuration errors.

The NE 800 may be configured to or operable to support a means for transmitting, to a second NE, a request message for a service operation, the request message including a resource URI for a HTTP POST method, and the service operation including one or more of an initial API configuration, an API configuration update, or an API invocation associated with an API provider; and receiving, from the second NE, a response message including a result of the service operation.

Additionally, the NE 800 may be configured to or operable to support any one or combination of where the request message further includes one or more data types for the request message; the one or more data types include information pertaining to one or more of the initial API configuration, the API configuration update, or the API invocation; the operation URI includes one or more of {apiRoot}/nsce-sam/<apiVersion>/Reqt, {apiRoot}/nsce-sam/<apiVersion>/UpdReqt, or {apiRoot}/nsce-sam/<apiVersion>/ApiInvoc; In some aspects, the techniques described herein relate to a method, further including receiving, from the second NE, a response including slice API information; the response includes {apiRoot}/nsce-sam/<apiVersion>/apiInfo}; the first NE includes a VAL server; the second NE includes a NSCE Server; the service operation pertains to one or more network slice APIs.

Additionally, or alternatively, the NE 800 may support at least one memory (e.g., the memory 804) and at least one processor (e.g., the processor 802) coupled with the at least one memory and configured to cause the NE to transmit, to a second NE, a request message for a service operation, the request message including a resource URI for a HTTP POST method, and the service operation including one or more of an initial API configuration, an API configuration update, or an API invocation associated with an API provider; and receive, from the second NE, a response message including a result of the service operation.

Additionally, the NE 800 may be configured to support any one or combination of where the request message further includes one or more data types for the request message; the one or more data types include information pertaining to one or more of the initial API configuration, the API configuration update, or the API invocation; the operation URI includes one or more of {apiRoot}/nscc-sam/<apiVersion>/Reqt, {apiRoot}/nsce-sam/<apiVersion>/UpdReqt, or {apiRoot}/nsce-sam/<apiVersion>/ApiInvoc; the at least one processor is configured to cause the first NE to receive, from the second NE, a response including slice API information; the response comprises {apiRoot}/nsce-sam/<apiVersion>/apiInfo}; the first NE includes a VAL server; the second NE includes a NSCE Server; the service operation pertains to one or more network slice APIs.

The NE 800 may be configured to or operable to support a means for receiving, from a first NE, a request message for a service operation, the request message including an operation URI for a HTTP POST method, and the service operation including one or more of an initial API configuration, an API configuration update, or an API invocation associated with an API provider; performing the service operation; and transmitting, to the first NE, a response message including a result of the service operation.

Additionally, the NE 800 may be configured to or operable to support any one or combination of where the request message further includes one or more data types for the request message; the one or more data types include information pertaining to one or more of the initial API configuration of the API configuration update; the response message includes one or more of {{apiRoot}/nsce-sam/<apiVersion>/Reqt, {apiRoot}/nsce-sam/<apiVersion>/UpdReqt, or {apiRoot}/nsce-sam/<apiVersion>/ApiInvoc; In some aspects, the techniques described herein relate to a method, further including transmitting, to the first NE, a response including slice API information; the response includes {apiRoot}/nsce-sam/<apiVersion>/apiInfo}; the first NE includes a VAL server; the second NE includes a NSCE Server; the service operation pertains to one or more network slice APIs.

Additionally, or alternatively, the NE 800 may support at least one memory (e.g., the memory 804) and at least one processor (e.g., the processor 802) coupled with the at least one memory and configured to cause the NE to receive, from a first NE, a request message for a service operation, the request message including an operation URI for a HTTP POST method, and the service operation including one or more of an initial API configuration, an API configuration update, or an API invocation associated with an API provider; perform the service operation; and transmit, to the first NE, a response message including a result of the service operation.

Additionally, the NE 800 may be configured to support any one or combination of where the request message further includes one or more data types for the request message; the one or more data types include information pertaining to one or more of the initial API configuration of the API configuration update; the operation URI includes one or more of {{apiRoot}/nsce-sam/<apiVersion>/Reqt, {apiRoot}/nsce-sam/<apiVersion>/UpdReqt, or {apiRoot}/nsce-sam/<apiVersion>/ApiInvoc; the at least one processor is configured to cause the second NE to transmit, to the first NE, a response including slice API information; the response comprises {apiRoot}/nsce-sam/<apiVersion>/apiInfo}; the first NE includes a VAL server; the second NE includes a NSCE Server; the service operation pertains to one or more network slice APIs.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to transmit, to a second NE, a request message for a service operation, the request message including a resource URI for a HTTP POST method, and the service operation including one of an initial API configuration or an API configuration update; and receive, from the second NE, a response message including a result of the service operation.

Additionally, the processor 900 may be configured to or operable to support any one or combination of where the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; the at least one controller is configured to cause the processor to receive, from the second NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive, from a first NE, a request message for a service operation, the request message including a resource URI for a HTTP POST method, and the service operation including one of an initial API configuration or an API configuration update; perform the service operation; and transmit, to the first NE, a response message including a result of the service operation.

Additionally, the processor 900 may be configured to or operable to support any one or combination of where the request message further includes one or more data types for the request message; the one or more data types include information pertaining to one or more of the initial API configuration of the API configuration update; the operation URI includes one or more of {apiRoot}/nsce-sac/<apiVersion>/Reqt or {apiRoot}/nsce-sac/<apiVersion>/UpdReqt; the at least one controller is configured to cause the processor to transmit, to the first NE, a response including slice API information; the response includes {apiRoot}/nsce-sac/<apiVersion>/apiInfo}; the first NE includes a VAL server; the second NE includes a NSCE Server; the service operation pertains to one or more network slice APIs.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to transmit, to a second NE, a request message for a service operation, the request message including a resource URI for a HTTP POST method, and the service operation including an API invocation associated with an API provider; and receive, from the second NE, a response message including a result of the service operation.

Additionally, the processor 900 may be configured to or operable to support any one or combination of where the request message further includes one or more data types for the request message; the one or more data types include information pertaining to one or more of an identifier for a network slice for which the API invocation is requested or authorization information for the API invocation; the operation URI includes {apiRoot}/nsce-sai/<apiVersion>/ApiInvoc; the first NE includes a VAL server; the second NE includes a NSCE Server; the service operation pertains to invocation of one or more network slice APIs; the response message includes one or more of a result of the API invocation or an indication of one or more configuration errors.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive, from a first NE, a request message for a service operation, the request message including a resource URI for a HTTP POST method, and the service operation including an API invocation associated with an API provider; perform the service operation; and transmit, to the first NE, a response message including a result of the service operation.

Additionally, the processor 900 may be configured to or operable to support any one or combination of where the request message further includes one or more data types for the request message; the one or more data types include information pertaining to one or more of an identifier for a network slice for which the API invocation is requested or authorization information for the API invocation; the at least one controller is configured to cause the processor to one or more of: verify, based at least in part on the information of the one or more data types, an identity of the first NE; or determine, based at least in part on the information of the one or more data types, whether the first NE is authorized to request the API invocation; the response includes {apiRoot}/nsce-sai/<apiVersion>/ApiInvoc; to perform the service operation, the at least one controller is configured to cause the processor to translate the API invocation to a service API invocation; to translate the API invocation to the service API invocation, the at least one controller is configured to cause the processor to map a network slice for the API invocation to the service API; the first NE includes a VAL server; the second NE includes a NSCE Server; the service operation pertains to invocation of one or more network slice APIs; the response message includes one or more of a result of the API invocation or an indication of one or more configuration errors.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to transmit, to a second NE, a request message for a service operation, the request message including a resource URI for a HTTP POST method, and the service operation including one or more of an initial API configuration, an API configuration update, or an API invocation associated with an API provider; and receive, from the second NE, a response message including a result of the service operation.

Additionally, the processor 900 may be configured to or operable to support any one or combination of where the request message further includes one or more data types for the request message; the one or more data types include information pertaining to one or more of the initial API configuration, the API configuration update, or the API invocation; the operation URI includes one or more of {apiRoot}/nsce-sam/<apiVersion>/Reqt, {apiRoot}/nsce-sam/<apiVersion>/UpdReqt, or {apiRoot}/nscc-sam/<apiVersion>/ApiInvoc; the at least one controller is configured to cause the processor to receive, from the second NE, a response including slice API information; the response comprises {apiRoot}/nsce-sam/<apiVersion>/apiInfo}; the first NE includes a VAL server; the second NE includes a NSCE Server; the service operation pertains to one or more network slice APIs.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive, from a first NE, a request message for a service operation, the request message including an operation URI for a HTTP POST method, and the service operation including one or more of an initial API configuration, an API configuration update, or an API invocation associated with an API provider; perform the service operation; and transmit, to the first NE, a response message including a result of the service operation.

Additionally, the processor 900 may be configured to or operable to support any one or combination of where the request message further includes one or more data types for the request message; the one or more data types include information pertaining to one or more of the initial API configuration of the API configuration update; the operation URI includes one or more of {{apiRoot}/nsce-sam/<apiVersion>/Reqt, {apiRoot}/nsce-sam/<apiVersion>/UpdReqt, or {apiRoot}/nsce-sam/<apiVersion>/ApiInvoc; the at least one controller is configured to cause the processor to transmit, to the first NE, a response including slice API information; the response comprises {apiRoot}/nsce-sam/<apiVersion>/apiInfo}; the first NE includes a VAL server; the second NE includes a NSCE Server; the service operation pertains to one or more network slice APIs.

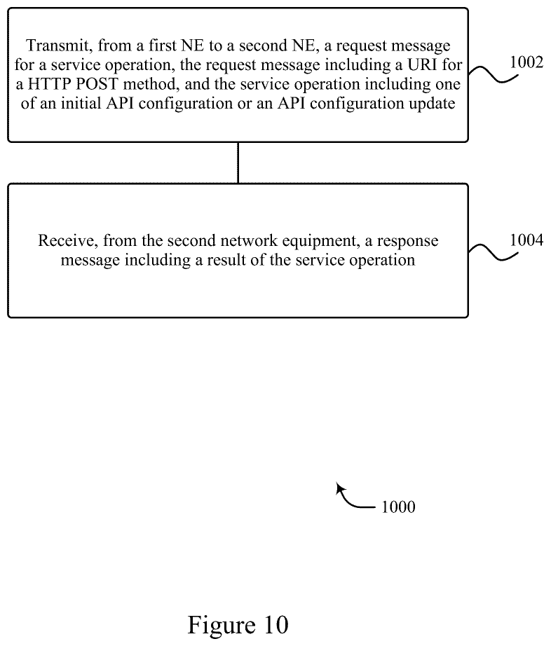

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting, from a first NE to a second NE, a request message for a service operation, the request message including a URI for a HTTP POST method, and the service operation including one of an initial API configuration or an API configuration update. The operations of 1002 may be performed in accordance with examples as described herein. In some implementations, aspects of the operations of 1002 may be performed by a NE as described with reference to FIG. 8.

At 1004, the method may include receiving, from the second NE, a response message including a result of the service operation. The operations of 1004 may be performed in accordance with examples as described herein. In some implementations, aspects of the operations of 1004 may be performed by a NE as described with reference to FIG. 8.

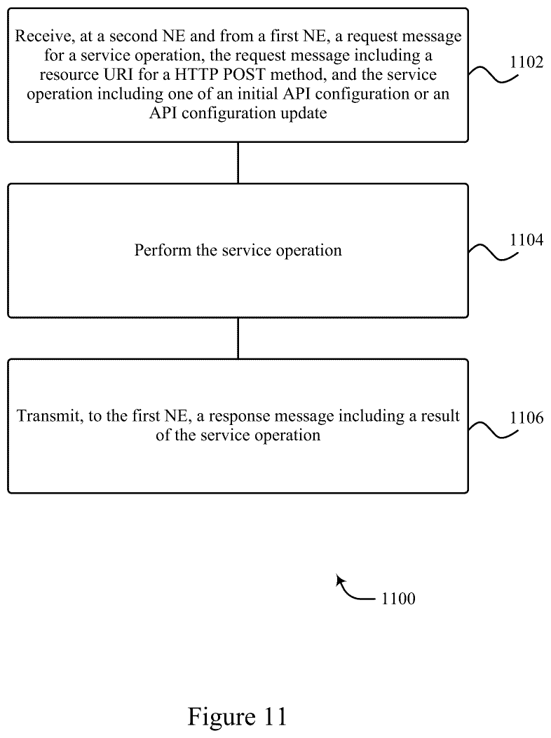

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include receiving, at a second NE and from a first NE, a request message for a service operation, the request message including a resource URI for a HTTP POST method, and the service operation including one of an initial API configuration or an API configuration update. The operations of 1102 may be performed in accordance with examples as described herein. In some implementations, aspects of the operations of 1102 may be performed by a NE as described with reference to FIG. 8.

At 1104, the method may include performing the service operation. The operations of 1104 may be performed in accordance with examples as described herein. In some implementations, aspects of the operations of 1104 may be performed by a NE as described with reference to FIG. 8.

At 1106, the method may include transmitting, to the first NE, a response message including a result of the service operation. The operations of 1106 may be performed in accordance with examples as described herein. In some implementations, aspects of the operations of 1106 may be performed a NE as described with reference to FIG. 8.

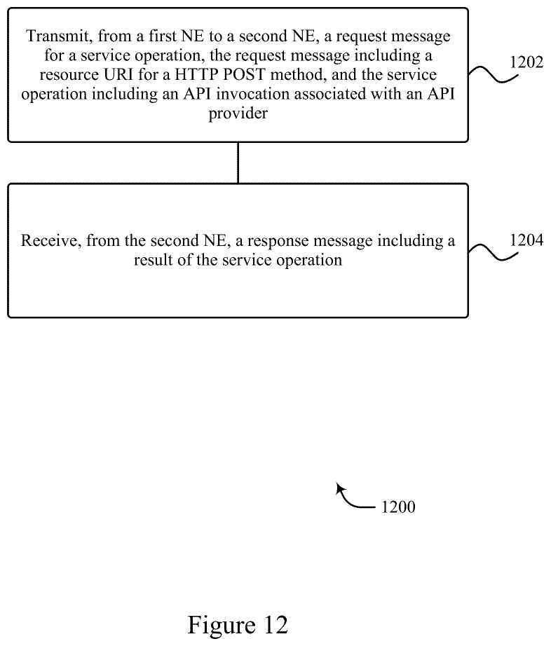

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include transmitting, from a first NE to a second NE, a request message for a service operation, the request message including a resource URI for a HTTP POST method, and the service operation including an API invocation associated with an API provider. The operations of 1202 may be performed in accordance with examples as described herein. In some implementations, aspects of the operations of 1202 may be performed by a NE as described with reference to FIG. 8.

At 1204, the method may include receiving, from the second NE, a response message including a result of the service operation. The operations of 1204 may be performed in accordance with examples as described herein. In some implementations, aspects of the operations of 1204 may be performed by a NE as described with reference to FIG. 8.

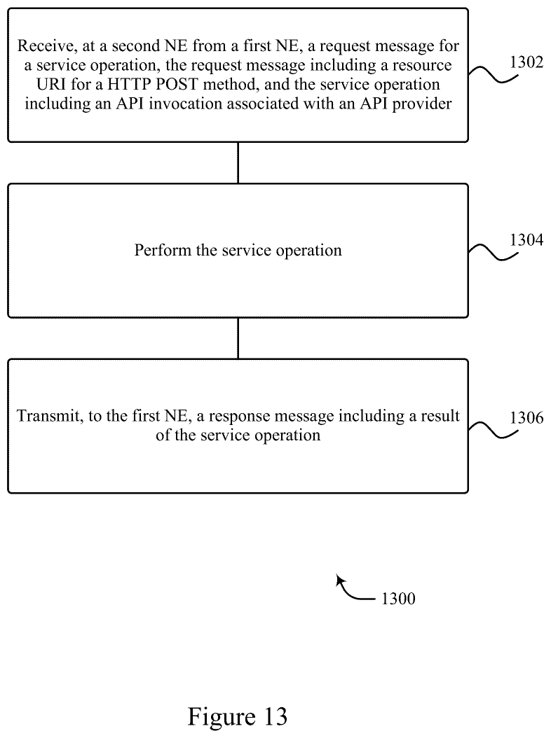

FIG. 13 illustrates a flowchart of a method 1300 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include receiving, at a second NE from a first NE, a request message for a service operation, the request message including a resource URI for a HTTP POST method, and the service operation including an API invocation associated with an API provider. The operations of 1302 may be performed in accordance with examples as described herein. In some implementations, aspects of the operations of 1302 may be performed by a NE as described with reference to FIG. 8.

At 1304, the method may include performing the service operation. The operations of 1304 may be performed in accordance with examples as described herein. In some implementations, aspects of the operations of 1304 may be performed by a NE as described with reference to FIG. 8.

At 1306, the method may include transmitting, to the first NE, a response message including a result of the service operation. The operations of 1306 may be performed in accordance with examples as described herein. In some implementations, aspects of the operations of 1306 may be performed a NE as described with reference to FIG. 8.

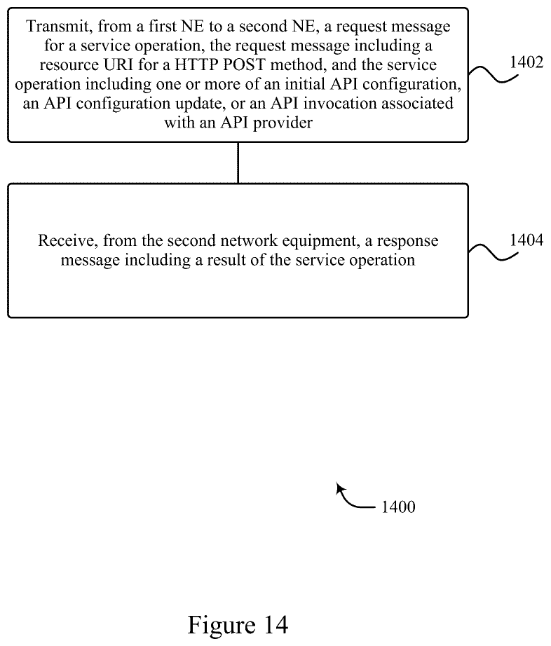

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting, from a first NE to a second NE, a request message for a service operation, the request message including a resource URI for a HTTP POST method, and the service operation including one or more of an initial API configuration, an API configuration update, or an API invocation associated with an API provider. The operations of 1402 may be performed in accordance with examples as described herein. In some implementations, aspects of the operations of 1402 may be performed by a NE as described with reference to FIG. 8.

At 1404, the method may include receiving, from the second NE, a response message including a result of the service operation. The operations of 1404 may be performed in accordance with examples as described herein. In some implementations, aspects of the operations of 1404 may be performed by a NE as described with reference to FIG. 8.

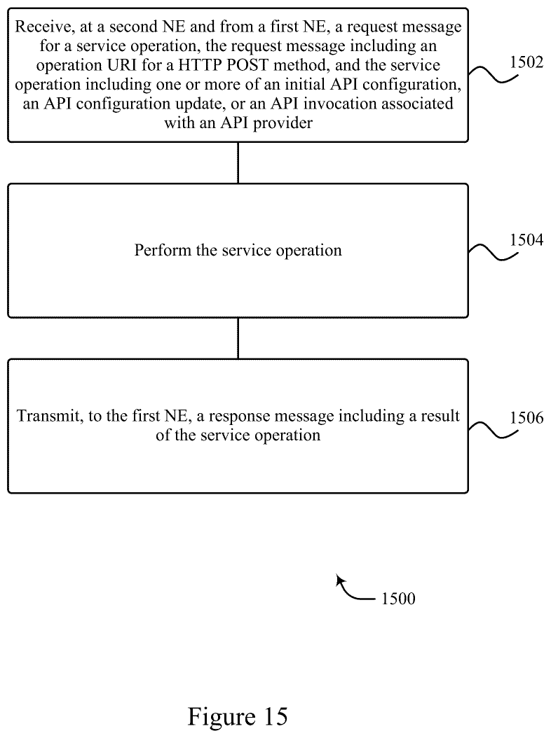

FIG. 15 illustrates a flowchart of a method 1500 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include receiving, at a second NE and from a first NE, a request message for a service operation, the request message including an operation URI for a HTTP POST method, and the service operation including one or more of an initial API configuration, an API configuration update, or an API invocation associated with an API provider. The operations of 1502 may be performed in accordance with examples as described herein. In some implementations, aspects of the operations of 1502 may be performed by a NE as described with reference to FIG. 8.

At 1504, the method may include performing the service operation. The operations of 1504 may be performed in accordance with examples as described herein. In some implementations, aspects of the operations of 1504 may be performed by a NE as described with reference to FIG. 8.

At 1506, the method may include transmitting, to the first NE, a response message including a result of the service operation. The operations of 1506 may be performed in accordance with examples as described herein. In some implementations, aspects of the operations of 1506 may be performed a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network equipment (NE) for wireless communication, comprising:
at least one memory; and
at least one processor coupled with the at least one memory and configured to cause the first NE to:
transmit, to a second NE, a request message for a service operation, the request message comprising a resource Uniform Resource Identifier (URI) for a Hypertext Transfer Protocol (HTTP) POST method, wherein the service operation comprises an API configuration update; and
receive, from the second NE, a response message comprising a result of the service operation.

2. The first NE of claim 1, wherein the request message further comprises one or more data types for the request message.

3. The first NE of claim 2, wherein the one or more data types comprise information pertaining to the API configuration update.

4. The first NE of claim 1, wherein the resource URI comprises {apiRoot}/nsce-sam/<apiVersion>/UpdReqt.

5. The first NE of claim 1, wherein the at least one processor is configured to cause the first NE to receive, from the second NE, a response comprising slice API information.

6. The first NE of claim 5, wherein the response comprises {apiRoot}/nsce-sam/<apiVersion>/apiInfo}.

7. The first NE of claim 1, wherein the first NE comprises a Vertical Application Layer (VAL) server.

8. The first NE of claim 7, wherein the second NE comprises a Network Slice Capability Exposure (NSCE) Server.

9. The first NE of claim 1, wherein the service operation pertains to one or more network slice APIs.

10. A second network equipment (NE) for wireless communication, comprising:
at least one memory; and
at least one processor coupled with the at least one memory and configured to cause the second NE to:
receive, from a first NE, a request message for a service operation, the request message comprising an operation Uniform Resource Identifier (URI) for a Hypertext Transfer Protocol (HTTP) POST method, wherein the service operation comprises an API configuration update;
perform the service operation; and
transmit, to the first NE, a response message comprising a result of the service operation.

11. The second NE of claim 10, wherein the request message further comprises one or more data types for the request message.

12. The second NE of claim 11, wherein the one or more data types comprise information pertaining to the API configuration update.

13. The second NE of claim 10, wherein the operation URI comprises {apiRoot}/nsce-sam/<apiVersion>/UpdReqt.

14. The second NE of claim 10, wherein the at least one processor is configured to cause the second NE to transmit, to the first NE, a response comprising slice API information.

15. The second NE of claim 14, wherein the response comprises {apiRoot}/nsce-sam/<apiVersion>/apiInfo}.

16. The second NE of claim 10, wherein the first NE comprises a Vertical Application Layer (VAL) server.

17. The second NE of claim 16, wherein the second NE comprises a Network Slice Capability Exposure (NSCE) Server.

18. The second NE of claim 10, wherein the service operation pertains to one or more network slice APIs.

19. A method performed by a first network equipment (NE), the method comprising:
transmitting, to a second NE, a request message for a service operation, the request message comprising a resource Uniform Resource Identifier (URI) for a Hypertext Transfer Protocol (HTTP) POST method, wherein the service operation comprises an API configuration update; and
receiving, from the second NE, a response message comprising a result of the service operation.

20. A method performed by a second network equipment (NE), the method comprising:
receiving, from a first NE, a request message for a service operation, the request message comprising an operation Uniform Resource Identifier (URI) for a Hypertext Transfer Protocol (HTTP) POST method, wherein the service operation comprises an API configuration update;
performing the service operation; and
transmitting, to the first NE, a response message comprising a result of the service operation.
